(19) United States
(12) Patent Application Publication
(10) Pub. No.: US 2013/0340240 A1
(43) Pub. Date: Dec. 26, 2013

(54) FASTENING DEVICE

(71) Applicant: Bin Juffri Irawan, Singapore (SG)

(72) Inventor: Bin Juffri Irawan, Singapore (SG)

(21) Appl. No.: 13/977,120

(22) PCT Filed: Dec. 30, 2011
(86) PCT No.: PCT/SG11/00458

§ 371 Date: Sep. 10, 2013

(30) Foreign Application Priority Data
Dec. 30, 2010 (SG) 201009743-4

(51) Int. Cl. F16B 25/10

(52) U.S. Cl. CPC F16B 25/10
USPC 29/525.11; 411/386

(57) ABSTRACT

In an embodiment, a fastener includes (a) a main body having a length parallel to a main axis definable through the main body, and a first cross-sectional area transverse to the main axis; and (b) at least a first set of petals carried by the main body, which includes at least one petal. The first set of petals is selectively displaceable (a) about the main axis in a direction transverse to the main axis, separate from or in the absence of axial displacement of the first set of petals in a direction parallel to the main axis, each petal within the first set of petals displaceable between a first position and a second position transverse to the main axis, the first position closer to the main axis than the second position; and (b) axially with respect to the main axis, separate from or in the absence of transverse displacement of the set of petals relative to the main axis. Such a fastener can create or mate with a hole having multiple distinct cross-sectional areas along a hole depth, including at least one cross-sectional area larger than the first cross-sectional area, which corresponds to laterally expanded petals.

### TECHNICAL FIELD

Particular embodiments of the present disclosure are directed to a penetrating, boring, restraining, retaining, joining, securing, gripping, clamping, fastening, and/or locking device having a main body that carries one or more sets of petals along a main body length, where such sets of petals are configured for selective lateral or transverse movement relative to an axis defined along or through the main body.

### BACKGROUND

Fastening devices are used to connect two or more components together. Currently available fastening devices can include nails, screws, bolts & nuts and rivets.

In engineering, woodworking and construction, a nail is a pin-shaped, sharp object of hard metal or alloy used as a fastener. Formerly made from wrought iron, today's nails are typically made of steel, often dipped or coated to prevent corrosion in harsh conditions or improve adhesion. Ordinary nails for wood are usually of a soft, low-carbon or “mild” steel (about 0.1% carbon, the rest iron and perhaps a trace of silicon or manganese). Nails used in concrete applications are harder, with 0.5-0.75% carbon.

Nails are typically driven into the workpiece by a hammer, a pneumatic nail gun, or a small explosive charge or primer. A nail holds materials together by friction in the axial direction and shear strength laterally. The point of the nail is also sometimes bent over or clinched after driving to prevent falling out. Nails are made in a great variety of forms for specialized purposes. The most common is a wire nail. Other types of nails include pins, tacks, brads, and spikes.

Unfortunately, nails have the least pull-out strength of any of the known fasteners. This is because the pull-out strength is very much dependent on its length. Existing nails lack structural aspects that can effectively reduce the effects of pull-out forces.

A screw is an externally threaded fastener capable of being inserted into holes in assembled parts, of mating with a preformed internal thread or forming its own thread, and of being tightened or released by applying torque to the head. Screws characteristically have a helical ridge, known as an external thread or just thread, wrapped around a cylinder. Some screw threads are designed to mate with a complementary thread, known as an internal thread, often in the form of a nut or an object that has the internal thread formed into it. Other screw threads are designed to cut a helical groove in a softer material, such as wood or plastic, as the screw is inserted. The most common uses of screws are to hold objects together and to position objects.

Often screws have a head, which is a specially formed section on one end of the screw that allows it to be turned, or driven. Common tools for driving screws include screwdrivers and wrenches. The head is usually larger than the body of the screw, which keeps the screw from being driven deeper than the length of the screw and to provide a bearing surface. There are exceptions; for instance, carriage bolts have a domed head that is not designed to be driven; set screws have a head smaller than the outer diameter of the screw; and J-bolts do not have a head and are not designed to be driven. The cylindrical portion of the screw from the underside of the head to the tip is known as the shank; it can be fully threaded or partially threaded.

The pull-out strength of a screw is dependent on such factors as the length of the screw, the number of threads per centimeter, the type of material the screw is applied to, etc. Screws have a pull-out strength that is somewhat greater than that of nails. In order to enhance the pull-out strength of a screw, plastic screw plugs can be inserted into the components. However, these plugs are generally made of plastic which can sometimes be easily broken or deformed. Alternately, expansion type screws can be used.

However, when a screw pulls out from the fastened component, severe damage can result to the component.

A bolt is an externally threaded fastener designed for insertion through holes in assembled parts, and is normally intended to be tightened or released by applying torque to a nut that is attached to the end of the bolt. An externally threaded fastener which is prevented from being turned during assembly and which can be tightened or released only by providing torque to one end or the other a nut is a bolt. Examples of bolts include round head bolts, track bolts, and plow bolts.

While the pull-out strength of a bolt can be very high, installing a bolt/nut combination requires that the bolt extend completely through the components. Oftentimes, the nut then projects out of the rear surface of the components. In many applications, there can be insufficient clearance for a bolt/nut combination to be used.

A rivet is a permanent mechanical fastener. Before being installed a rivet consists of a smooth cylindrical shaft with a head on one end. The end opposite the head is called the buck-tail. On installation the rivet is placed in a punched or pre-drilled hole, and the tail is upset, or bucked (i.e. deformed), so that it expands to about 1.5 times the original shaft diameter, holding the rivet in place. To distinguish between the two ends of the rivet, the original head is called the factory head and the deformed end is called the shop head or buck-tail. Because there is effectively a head on each end of an installed rivet, it can support tension loads (loads parallel to the axis of the shaft); however, it is much more capable of supporting shear loads (loads perpendicular to the axis of the shaft). Bolts and screws are better suited for tension applications.

Unfortunately, rivets can be very difficult to remove. Additionally, in order to install a rivet, there must be access available to both sides of the component(s).

It would therefore be a great improvement in the art if a fastener could be developed which addresses one or more of the above mentioned problems.

### SUMMARY

In accordance with an aspect of the present disclosure, a device configured for at least one of a penetrating into, boring into, restraining, retaining, joining, securing, gripping, clamping, fastening, and locking portions of a set of objects, components, or tissues includes a main body having a length parallel to a main axis definable through the main body, the main body having a first cross-sectional area transverse to the main axis; and at least a first set of petals carried by the main body and comprising at least one petal, the first set of petals selectively displaceable about the main axis in a direction transverse to the main axis in the absence or substantial absence of axial displacement of the first set of petals in a direction parallel to the main axis, each petal within the first set of petals displaceable (e.g., incrementally and simultaneously displaceable) between a first position and a second position transverse to the main axis, the first position closer to the main axis than the second position.

The first position corresponds to a retracted position in which the first set of petals is disposed at least substantially within the first cross-sectional area, and the second position corresponds to an extended position in which the first set of petals is disposed beyond the first cross-sectional area in a manner that defines a second cross-sectional area larger than the first cross-sectional area. The second position can correspond to a transverse petal displacement range that defines a maximum lateral distance across which the first set of petals is displaceable relative to the main axis. The first set of petals can include at least two petals, each of which has a corresponding transverse cross section disposed parallel to a petal displacement plane defined perpendicular to the main axis.

In accordance with another aspect of the present disclosure, the first set of petals is further selectively axially displaceable along a direction parallel to the main axis, for instance, in the absence or substantial absence of transverse displacement of the first set of petals along a direction transverse to the main axis. A device in accordance with an aspect of the present disclosure can be configured for selective transverse displacement of the set of petals relative to the main axis separate from selective axial displacement of the set of petals relative to the main axis.

In accordance with a further aspect of the present disclosure, the device can include a second set of petals carried by the main body and comprising at least one petal, the second set of petals selectively displaceable about the main axis in a direction transverse to the main axis in the absence or substantial absence of axial displacement of the second set of petals. Each petal within the second set of petals is displaceable (e.g., incrementally and simultaneously displaceable) between the first position and at least one of the second position and a third position transverse to the main axis, the third position farther from the main axis than each of the first position and the second position.

In accordance with a further aspect of the present disclosure, at least one of the first set of petals and the second set of petals is also configured for axial displacement in a direction parallel to the main axis, for instance, selective axial displacement in a direction parallel to the main axis separate from or in the absence or substantial absence of lateral displacement in a direction transverse to the main axis.

In accordance with an aspect of the present disclosure, at least a portion of an external surface of the main body and/or a portion of an external surface of the first set of petals carries threads. The first set of petals can be configured for selective lateral displacement relative to the main axis separate from or concurrent with rotational motion of the main body.

In accordance with an another aspect of the present disclosure, the device further includes a displacement control member such as a rod disposed parallel to the main axis along a portion of the main body's length; and a force transfer mechanism coupled to the displacement control member and the first set of petals, the force transfer mechanism configured to convert a force (e.g., a rotational force) imparted to the displacement control member to a lateral displacement of the first set of petals. The force transfer mechanism can include one or more of a set of plates rotatable about the main axis, a set of gears rotatable about the main axis, a cone axially displaceable relative to the main axis, and a cylinder axially displaceable relative to the main axis.

The device can additionally include a petal displacement control interface accessible at a proximal end of the device and configured for mating engagement with a force transfer element external to the device, the petal displacement control interface coupled to the displacement control member. The petal displacement control interface can correspond to a conventional standardized engagement structure such as a screw head interface configured to mate with at least one of a hand tool and a power tool.

The device can further include a petal displacement guide member coupled to each petal within the set of petals and defining a petal displacement plane perpendicular to the main axis and to which a transverse cross section of each petal within the first set of petals remains parallel during displacement of the first set of petals. The device can also include a lateral displacement limitation mechanism couplable to each petal within the first set of petals, the lateral displacement limitation mechanism configured for defining a lateral displacement range transverse to the main axis within which each petal within the first set of petals is displaceable.

In accordance with an aspect of the present disclosure, a process for creating a hole by way of a fastener having a main body having a length and carrying a set of petals, the main body defining a first cross-sectional area, includes inserting the fastener into an object to define a primary hole until a distal end of the fastener is disposed at a primary depth at a distal end of the primary hole; and laterally displacing the set of petals outward from the length of the main body in the substantial absence of axial displacement of the set of petals in a direction parallel to the length of the main body to define a set of cavities extending laterally away from the length of the main body and the primary depth of the primary hole, each set of cavities defining a second cross-sectional area larger than the first cross-sectional area.

The process can further involve axially displacing in a direction parallel to the length of the main body to enlarge the set of cavities, where such axial displacement can occur in the absence or substantial absence of lateral displacement of the set of petals relative to the main body's length. The process can also involve rotating the main body within the primary hole in association with at least one of laterally displacing the set of petals and axially displacing the set of petals.

### BRIEF DESCRIPTION OF THE DRAWINGS

FIG. 1 is a schematic illustration showing aspects of a fastener in accordance with an embodiment of the present disclosure.

FIGS. 2A-2B are schematic illustrations showing additional aspects of a fastener in accordance with an embodiment of the present disclosure.

FIG. 3A is a perspective view of an embodiment of a fastener in a closed position in accordance with an embodiment of the present disclosure.

FIG. 3B is a perspective view of the fastener of FIG. 3A in an open/engaged position.

FIG. 4A is a side view of the fastener shown in FIG. 3A.

FIG. 4B is a side view of the fastener shown in FIG. 3B.

FIG. 5A is an exploded perspective view of the fastener shown in FIGS. 3A-4B.

FIG. 5B is an exploded perspective view further detailing portions of the fastener shown in FIG. 5A.

FIGS. 6-9 are plan views illustrating particular elements of the fastener of FIGS. 3A-5B.

FIG. 10A is a cross-sectional side view of a fastener inserted into a hole and coupling, holding, retaining, securing, joining, or connecting a set of objects, components, or tissues in accordance with an embodiment of the present disclosure.

FIG. 10B is a cross-sectional side view of a fastener inserted into another hole and coupling, holding, retaining, securing, joining, or connecting a set of objects, components, or tissues in accordance with another embodiment of the present disclosure.

FIG. 11A is a schematic illustration of a fastener configured as a pedicle screw in accordance with an embodiment of the present disclosure.

FIG. 11B is a schematic illustration of the pedicle screw of FIG. 11A in an initial, unexpanded, non-deployed, or closed position in accordance with an embodiment of the present disclosure.

FIG. 11C is a schematic illustration of the pedicle screw of FIGS. 11A and 11B in a final, expanded, deployed, secured, or open position in accordance with an embodiment of the present disclosure.

FIGS. 11D-11H are representative illustrations showing a pedicle screw insertion and deployment process in accordance with an embodiment of the present disclosure.

FIG. 12A is a schematic illustration of a fastener configured as an intramedullary nail in accordance with an embodiment of the present disclosure.

FIGS. 12B-12L are representative illustrations showing an intramedullary nail insertion and deployment process in accordance with an embodiment of the present disclosure.

FIG. 13 is a schematic illustration of a fastener configured as an interference screw in accordance with an embodiment of the present disclosure.

FIG. 14 is a schematic illustration of a fastener configured as a dynamic hip screw in accordance with an embodiment of the present disclosure.

FIG. 15A is a schematic illustration of a fastener configured as a dental implant in accordance with an embodiment of the present disclosure.

FIGS. 15B-15E are representative illustrations showing a dental implant insertion and deployment process in accordance with an embodiment of the present disclosure.

FIG. 16 is a schematic illustration of a fastener configured as a drill bit/reamer or boring/tunneling tool in accordance with an embodiment of the present disclosure.

FIG. 17 is a schematic illustration of a fastener configured as a screw in accordance with an embodiment of the present disclosure.

FIG. 18 is a schematic illustration of a fastener cam mechanism that includes a set of rails in accordance with an embodiment of the present disclosure.

FIG. 19 is a schematic illustration of a fastener that includes an inverted cone and rail mechanism for engaging and displacing petals in accordance with an embodiment of the present disclosure.

FIG. 20 is a schematic illustration of a fastener that includes a cylinder and sloped rail mechanism for engaging and displacing petals in accordance with an embodiment of the present disclosure.

FIG. 21A is a schematic illustration of a fastener that includes a radial and axial petal positioning mechanism in accordance with another embodiment of the present disclosure.

FIG. 21B is a schematic illustration further detailing portions of the fastener of FIG. 21A.

FIGS. 22A-22C are schematic illustrations of various representative petal configurations in accordance with particular embodiments of the present disclosure.

FIG. 23 is an illustration of various representative main body/shaft and petal configurations in accordance with particular embodiments of the present disclosure.

FIG. 24 is a flow diagram of a hole creation and/or fastener insertion process in accordance with an embodiment of the present disclosure.

### DETAILED DESCRIPTION

In the present disclosure, the depiction of a given element or consideration or use of a particular element number in a particular FIG. or a reference thereto in corresponding descriptive material can encompass the same, an equivalent, or an analogous element or element number indicated or identified in another FIG. or descriptive material associated therewith.

As used herein, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a portion of a system, an apparatus, an object, a device, a structure, a structural feature, a surface, an interface, a physical parameter, or a value depending upon the type of set under consideration.

Structural and Functional Overview

Embodiments in accordance with the present disclosure provide a new generation of penetrating, boring, restraining, retaining, joining, securing, gripping, clamping, fastening, and/or locking systems, apparatuses, assemblies, tools, devices, and/or elements that can be configured for one or more of the following:
(a) creating a hole, slot, passage, channel, portal, tunnel, corridor, conduit, foramen, or fenestra (hereafter referred to as “hole” for purpose of brevity and clarity) having a depth or length that extends between an entry aperture, opening, orifice, or site and a terminus, and which includes multiple spatial dimensions relative to a reference, main, primary, longitudinal, symmetry, and/or central axis defined parallel or central to its depth, where such spatial dimensions include:
   (i) a first dimension having a first cross-sectional area (e.g., a first diameter) transverse to the main axis, which exists along one or more spatial portions, segments, or sections of the hole between the hole's entry site and terminus, such as a first (e.g., initial) spatial segment of the hole; and
   (ii) a number of additional dimensions distinguishable or distinct from the first dimension, including at least a second dimension having a second cross-sectional area (e.g., corresponding to a second diameter) transverse to the main axis, the second cross-sectional area larger than the first cross-sectional area, where the second dimension exists along one or more spatial sections of the hole between the entry site and the terminus, such as a second spatial segment of the hole that is closer to the terminus of the hole/further from the entry site of the hole than the first spatial segment;
(b) filling, substantially filling, partially filling, or providing access to one or more portions of the aforementioned hole on a temporary, long-term, or essentially permanent basis; and
(c) selectively securing, retaining, or holding in position or together one or more portions of objects, structural elements, components, surfaces, interfaces, or bodily tissues disposed along the depth of the hole.

Each of the foregoing additional spatial dimensions can spatially correspond to or define one or more peripheral or side cavities, chambers, or passages that are internal to the hole along the hole's depth, and which are external or adjacent to the hole's first cross-sectional area or diameter. Depending upon embodiment details, the aforementioned additional spatial dimensions can include a second spatial dimension distinct from the first spatial dimension; a third spatial dimension distinct from each of the first and second spatial dimensions; and possibly additional spatial dimensions (e.g., a fourth spatial dimension) distinct from each of the first, second, and third spatial dimensions. In certain embodiments, particular additional spatial dimensions can exhibit identical or essentially identical cross-sectional areas, but can be spatially offset or translated (e.g., angularly offset) with respect to each other relative to or about the main axis of the hole.

In some embodiments, a hole as set forth above includes an entry site but lacks an exit aperture, opening, orifice or site, such that the terminus of the hole remains internal to or restricts access beyond an environment, material, or set of structures or tissues in which the hole is disposed. In other embodiments, the terminus of a hole is itself an exit aperture, opening, orifice, or site, and thus the hole includes or defines a passage entirely therethrough from the hole's entry site to its exit site, and thus the hole can be defined as a through-hole. In such embodiments, at least some unimpeded/unobstructed or generally unimpeded/unobstructed material, fluid, or signal (e.g., optical or acoustic signal) transfer or communication can occur through the hole between the hole's entry site and its exit site. In addition to the foregoing, a peripheral or side cavity, chamber, or passage corresponding to an aforementioned additional dimension (e.g., a second dimension) along the depth of the hole can remain internal to an environment, material, or set or structures or tissues in which the chamber resides, or can include or provide an aperture, opening, orifice, site, or access point that is exposed or exposable to an environment external to the hole, in which case such a peripheral or side passage can be defined as a through-passage.

In association with the foregoing, various embodiments in accordance with the present disclosure provide a penetrating, boring, restraining, retaining, joining, securing, gripping, clamping, fastening, and/or locking structure, apparatus, mechanism, assembly, tool, or device (hereafter referred to as “fastener” for purpose of brevity and clarity) having a main body, shaft, or shank that defines or provides a first cross-sectional area (e.g., corresponding to or defining a first outer diameter) along a main body length or height extending between (a) a first, proximal, access, interface, or externally disposable/externally accessible/external portion or end of the main body that is configured to facilitate or enable fastener coupling to or engagement with one or more types of insertion, engagement, and/or deployment tools or devices (e.g., which reside at least partially, substantially, or entirely external to the above-referenced hole); and (b) a second, distal, or internally disposable portion or end of the main body, which is configured to initiate (a) the creation of a hole as set forth above, and/or (b) entry of the fastener into such a hole. A reference, main, primary, longitudinal, symmetry, and/or central axis of the fastener can be defined that extends parallel to or through the main body along the main body's length.

The fastener is configurable for alignment in and/or mating engagement with one or more portions a hole as set forth above. In situations in which a hole includes an entry site but lacks an exit site, the main body's distal end is configured to reside at the terminal end of the hole when the fastener is fully disposed therein. In situations in which a hole includes an entry site as well as an exit site (i.e., a through-hole situation), the distal end of the fastener's main body is configured to reside beyond the hole's exit site when the fastener is fully disposed along or across the hole's depth.

The main body of the fastener carries one or more sets of displaceable structures, parts, members, elements, or petals (hereafter referred to as “petals” for purpose of brevity and clarity) along its length, which can be selectively and/or preferentially activated, exposed, actuated, displaced, or deployed lateral to (e.g., transversely or radially outward and/or inward) or beyond the fastener's main body (e.g., along or in a set of directions transverse or perpendicular to the main body's length). Thus, a given set of petals can be selectively displaced about the fastener's main axis, in a direction transverse to the main axis. Such lateral displacement of a set of petals about the fastener's main axis can involve lateral spatial translation of individual petals away from or toward the main axis and/or each other (e.g., spatial expansion of the set of petals, such that individual petals are laterally displaced away from each other, and/or spatial contraction of the set of petals, such that individual petals are laterally displaced toward each other). The transverse or lateral displacement or translation of petals away or outward from the main body thereby defines at least a second cross-sectional area (e.g., corresponding to or defining a second outer diameter) that is larger than the first cross-sectional area. Such a second cross-sectional area can correspond to an additional dimension (e.g., a second dimension) of a hole as set forth above. Depending upon embodiment and/or application details, petals can be radially displaced relative to (e.g., away from and/or toward) the fastener's main body in association with the creation of a hole as set forth above (e.g., during hole creation, possibly concurrent with rotation of the main body itself about the fastener's main axis, such as in association with a drilling process involving the creation of a hole in one or more objects, components, or tissues by way of drill-type rotation of the main body), and/or after the creation of such a hole.

Any given set of petals can be carried along or by a main body portion or segment or at a main body location that is offset from the fastener's proximal end, toward or proximate to the fastener's distal end. In several embodiments, at least a first set of petals is disposed away from the fastener's proximal end toward the fastener's distal end, such that a proximal portion, segment, or section of the main body exhibiting the first cross-sectional area exists between the fastener's proximal end and the first set of petals.

Individual petals within any given set of petals can be displaced in a direction transverse, lateral, radial, perpendicular, or horizontal to the main body's length or the main axis to thereby protrude beyond the transverse or cross-sectional extent of the main body and thus beyond or past the first cross-sectional area provided by the main body. More particularly, when individual petals within a given set of petals are displaced (e.g., simultaneously displaced) transverse to the main body's length, corresponding or common transverse portions of such individual petals can simultaneously reside, or travel in and/or remain parallel to a common petal displacement plane defined perpendicular to the main body's length or the main axis.

In multiple embodiments, any given set of petals exists in a first, initial, retracted, withdrawn, or undeployed configuration or position prior to lateral, transverse, radial, perpendicular, or horizontal displacement or deployment of the set of petals away from the main body. While in the undeployed configuration, exterior, external, exposed, or outer surfaces of individual petals within a set of petals can remain within or substantially within (e.g., is flush or substantially flush with) the first cross-sectional area provided by the main body. For instance, when a set of petals exists in an undeployed configuration, an outer diameter corresponding to or defined by exterior, external, exposed, or outer surfaces of the set of petals can match or approximately match an outer diameter defined by portions of the main body adjacent or proximate to the set of petals.

When a set of petals exists in an undeployed configuration, in a number of embodiments at least a portion of each individual petal within the set of petals is received by or positioned within (e.g., at least partially received by, or substantially or entirely positioned within) a corresponding opening, slot, recess, compartment, or chamber provided by the main body. Such openings, slots recesses, compartments, or chambers in the main body can be shaped and dimensioned for generally or substantially conformal alignment or mating with portions (e.g., peripheral boundaries) of corresponding petals. Furthermore, a gap, discontinuity, break, or separation can exist between the periphery or border(s) of an opening, slot, recess, compartment, or chamber in the main body and peripheral or border portions of a petal configured for positioning therein or therealong or receipt thereby. Consequently, exterior, external, exposed, or outer surfaces or individual petals are separate or separable from exterior, external, exposed, or outer surfaces of the main body proximate to the petals under consideration

In several embodiments, individual petals within each set of petals are circumferentially or generally circumferentially disposed about the main body or the main axis corresponding thereto. In various embodiments, within a given set of petals, at least a portion of each petal's exterior surface exhibits a geometric profile (e.g., an arcuate or annular profile or curved shape) that at least generally corresponds or conforms to, matches, or mates or engages with a geometric profile corresponding to the main body (e.g., a cylindrical, generally cylindrical, or annular shape) when the petals are carried or disposed in the undeployed configuration. A fastener in accordance with such embodiments of the present disclosure can thus define or exhibit a uniform or generally uniform overall geometric profile or shape corresponding to or at least substantially maintaining the main body's cross-sectional area when the petals are carried or disposed in the undeployed configuration.

In various embodiments, individual petals within a given set of petals can be transversely or laterally displaced along a corresponding transverse or lateral petal positioning or travel direction, and within or across a transverse or lateral petal positioning or travel range or span. Each lateral petal positioning direction along which a given petal can laterally travel, as well as the lateral petal positioning range, is defined lateral, transverse, radial, perpendicular, or horizontal to the fastener's shaft or main axis. For each individual petal within a set of petals, a corresponding lateral petal positioning direction within a set of lateral petal positioning directions can be defined, where each lateral petal positioning direction is transverse or perpendicular to the fastener's main axis, and each such direction is parallel to or resides in a common petal displacement plane. A lateral petal positioning range or span associated with a given set of petals can define a maximum lateral distance across which individual petals within the set of petals can laterally travel relative to the fastener's main axis.

The lateral, transverse, radial, or horizontal displacement of individual petals within a set of petals along, across, or through the lateral petal positioning range can occur in a simultaneous and substantially or essentially continuous, progressive, incremental, smooth, and/or reversible manner. Depending upon embodiment details, multiple distinct sets of petals can be laterally displaced away from the fastener's main body in a simultaneous or essentially simultaneous manner, or particular sets of petals can be laterally displaced away from the main body in a selective, preferential, or sequential manner relative to other sets of petals.

In addition to the lateral, radial, perpendicular, or horizontal displacement of petals relative to (e.g., away from or toward) the fastener's main axis or the main body's length, in a number of embodiments one or more sets petals can also be axially, longitudinally, or vertically translated in a direction parallel to or along the main axis or the main body's length, along or within an axial, longitudinal, or vertical petal positioning range. Such axial displacement of petals can occur in a selective or selectable manner, or on an as-desired or as-needed basis, and can involve the simultaneous axial displacement of multiple individual petals within a given set of petals, and possibly the simultaneous axial displacement of multiple distinct sets of petals.

In several embodiments, within a given set of petals, the lateral, transverse, radial, or horizontal displacement of individual petals across a lateral petal positioning range transverse or perpendicular to the main body's length/main axis occurs in a manner that is sequential, separate, or separable with respect to or temporally distinct from longitudinal or axial displacement of such petals within an axial petal positioning range parallel to or along the main body's length/main axis. For instance, petals can first be radially displaced transverse or perpendicular to the main body's length across the extent of a lateral petal positioning range prior to axial petal motion (e.g., during a transverse or lateral petal displacement interval), after which petals can be axially displaced parallel to the main body's length within or across an axial petal positioning range in a manner substantially distinct from radial petal displacement (e.g., during an axial petal displacement interval distinct from the transverse or lateral petal displacement interval).

In view of the foregoing, a given set of petals carried by the main body can be selectively or preferentially radially displaced relative to fastener's main axis in the absence or substantial absence of axial displacement of the set of petals parallel to the main axis. Thus, individual petals within a given set of petals can be selectively preferentially displaced transverse, lateral, or perpendicular to the fastener's main axis separate from or in the absence or in lieu of axial displacement of such petals parallel to the main axis.

As indicated above, in a number of fastener embodiments in accordance with the present disclosure, corresponding, corollary, counterpart, or common transverse portions or cross-sections of individual petals within a given set of petals are configured to remain parallel to or reside or travel in a common or shared petal displacement plane in response to a displacement force communicated or imparted to the set of petals, where the petal displacement plane is perpendicular or substantially perpendicular to the main body's length or the main axis. Thus, during lateral displacement of a set of petals relative to the fastener's main axis, a common transverse portion or cross-section of each petal within the set of petals is parallel to or resides in a common petal displacement plane. Moreover, during axial displacement of a set of petals relative to the fastener's main axis, a common transverse portion or cross-section of each petal within the set of petals resides in the common petal displacement plane.

Structural and/or functional aspects of a fastener in accordance with embodiments of the present disclosure can vary in accordance with a number of factors, including but not limited to (a) a number, spatial position, and spatial orientation of chambers; and/or (b) a number of distinct or different spatial dimensions, cross-sectional areas, or diameters that a hole exhibits or is intended to exhibit along its depth. In general, various embodiments of a fastener in accordance with an embodiment of the present disclosure provides a larger or bigger cross-sectional area or diameter than a smaller cross-sectional area or diameter of the fastener's main body, shaft, or shank, where the larger cross-sectional area is parallel or substantially parallel to the length or main axis of the main body, shaft, or shank. Such a larger cross-sectional area or diameter can provide a restraining or retaining member or stopper configured to resist or inhibit unintended withdrawal or pull-out of the fastener from a hole in which the fastener is disposed, such as a fastener—hole configuration in which petals carried by the fastener are matingly engaged with some or all of the hole's peripheral or side chambers.

Structural and Functional Aspects of Particular Representative Embodiments

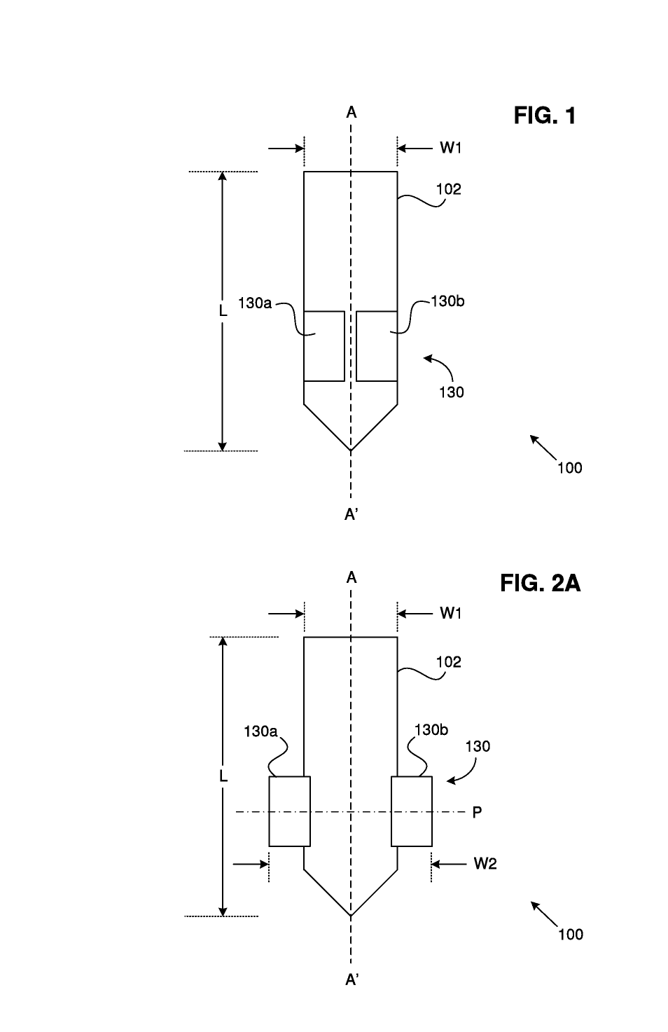

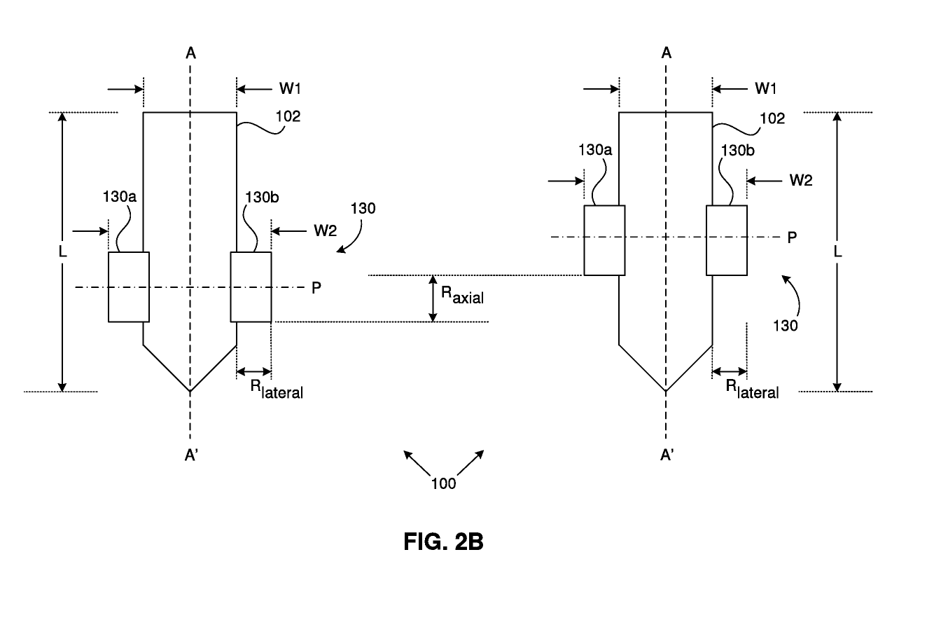

FIGS. 1 and 2A-2B are schematic illustrations showing aspects of a fastener 100 in accordance with an embodiment of the present disclosure. As indicated in FIGS. 1 and 2A-2B, a fastener 100 includes a main body 102 having a length L and which defines or exhibits a first transverse extent or width W1 relative to its length, where the first transverse extent or width W1 is correlated with or corresponds to a first cross-sectional area defined transverse or perpendicular to the main body's length L. A main axis of the fastener 100 (corresponding to line segment A-A′ shown in FIGS. 1 and 2A-2B) can be defined parallel to, along, or through the main body 102.

The main body 102 is coupled to or carries at least one set of displaceable petals 130. Each set of petals 130 includes a number of individual petals 130a, 130b, for instance, one, two, three, four, or more (e.g, eight, ten, etc . . . ) individual petals 130a,b. Each set of petals 130 is displaceable in at least a transverse or perpendicular direction relative to the fastener's main axis, such that outer surfaces of individual petals 130a,b can extend beyond the fastener's first transverse extent or width W1 to define a second transverse extent or width W2 corresponding to the fastener 100. The second transverse extent or width W2 is correlated with or corresponds to a second cross-sectional area that is greater than the fastener's first cross-sectional area. Thus, the fastener 100 exhibits at least two distinct cross-sectional areas. A distance between W1 and W2 can define a lateral petal displacement range or span, in a manner further described in detail below, and hence any given fastener 100 exhibits at least one lateral displacement range across or within which the set(s) of petals 130 carried by the given fastener 100 can be laterally displaced.

In various embodiments, one or more sets of petals 130 can be laterally, transversely, radially, perpendicularly, or horizontally (a) extended away from, or (b) drawn in or retracted toward the fastener's main axis in a selectable manner at any given time. Corresponding or common portions or cross-sections of individual petals 130a,b within a set of petals 130 can reside, travel, and/or remain in a common petal displacement plane P defined transverse or perpendicular to the fastener's main axis.

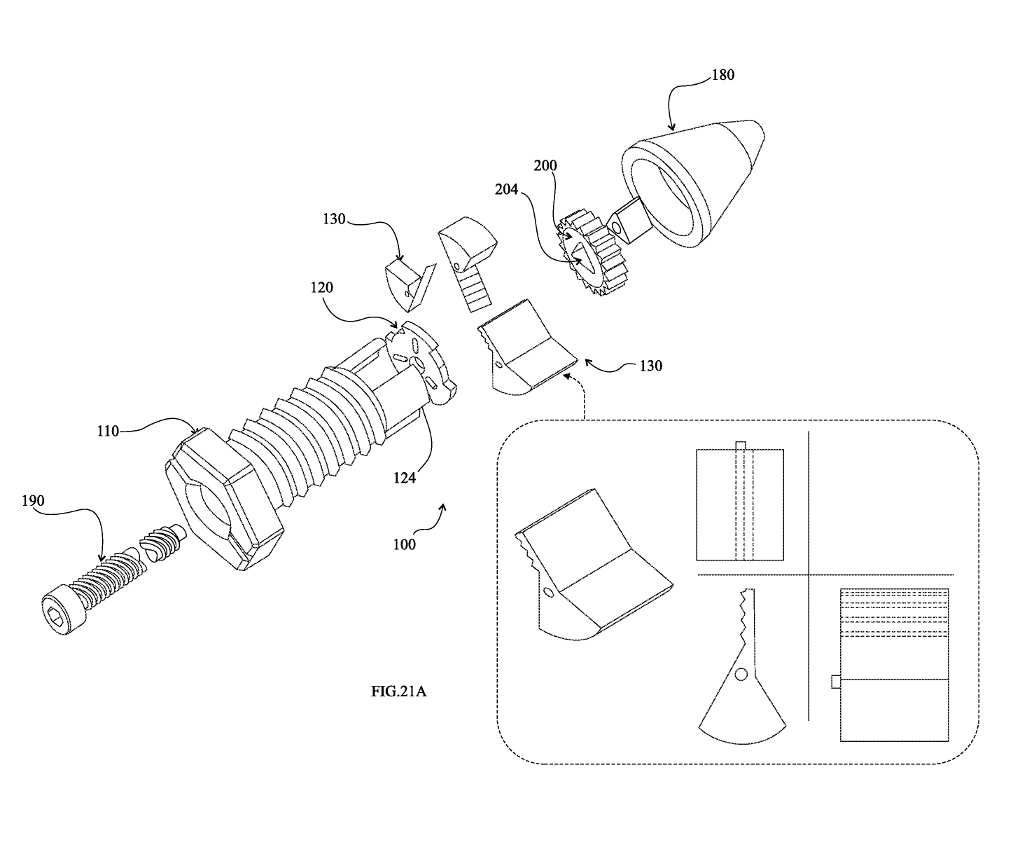

As indicated in FIG. 2B, a lateral petal positioning, displacement, translation, or travel range or span Rₗₐₜₑᵣₐₗ can define a maximum distance across which petals 130a,b can be displaced lateral to the fastener's main axis. Similarly, an axial petal positioning, displacement, translation, or travel range or span Rₐₓᵢₐₗ can define a maximum distance across which petals 130a,b can be axially displaced parallel to the fastener's main axis. In general, a lateral petal positioning range Rₗₐₜₑᵣₐₗ can be less than or approximately equal to one-half of a main body transverse dimension or width W1. In certain embodiments (e.g., corresponding to an inverted cone, cylinder, or gear configuration described below with reference to FIGS. 19-21B, respectively), a lateral petal positioning range Rₗₐₜₑᵣₐₗ can be at least slightly greater than one-half of the main body's width W1. An axial petal positioning range Rₐₓᵢₐₗ can be a predetermined portion of the main body's length L, for instance, a small or very small portion (e.g., approximately 1%-10%) of the main body's length L, or a significant or substantial portion (e.g., more than approximately 10%, or about 10%-20%, 30%, 40%, or 50%) of the main body's length L.

In several embodiments, lateral petal displacement transverse to the fastener's main axis can occur separate, independent, or substantially exclusive of axial petal displacement parallel to the main axis. Additionally, in a number of embodiments, petals 130a,b can be incrementally or progressively positioned at an intended, desired, or required location within one or both of a lateral petal positioning range Rₗₐₜₑᵣₐₗ and an axial petal positioning range Rₐₓᵢₐₗ.

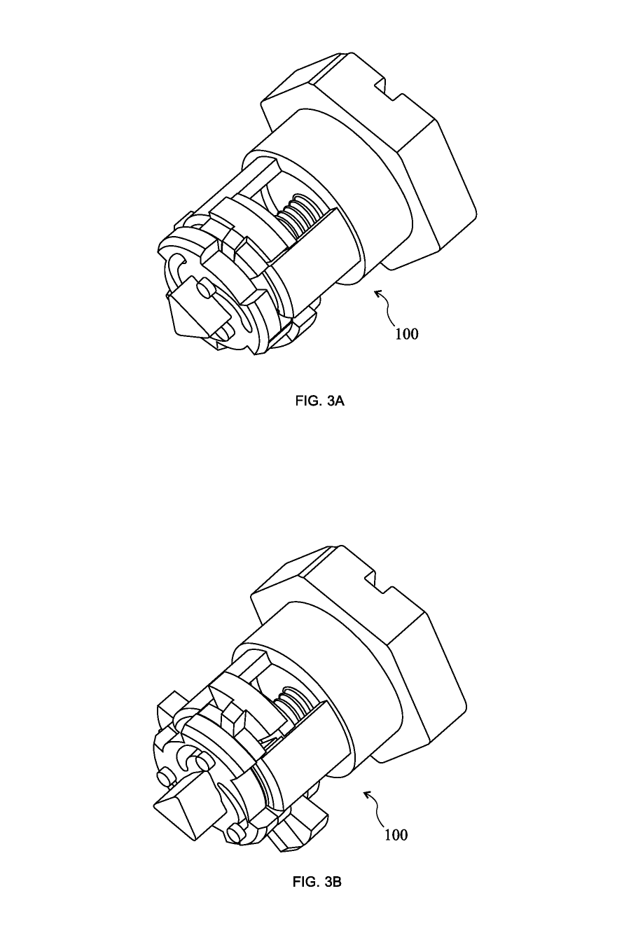

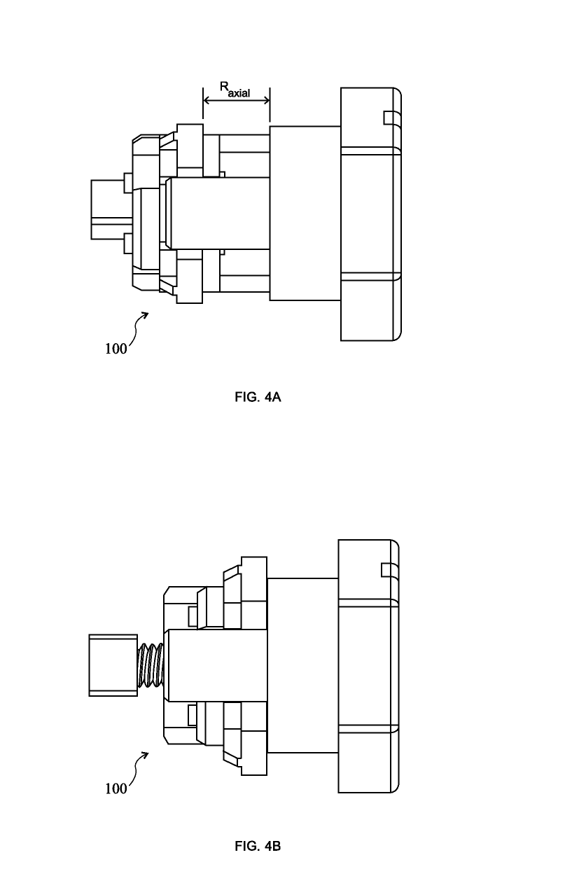

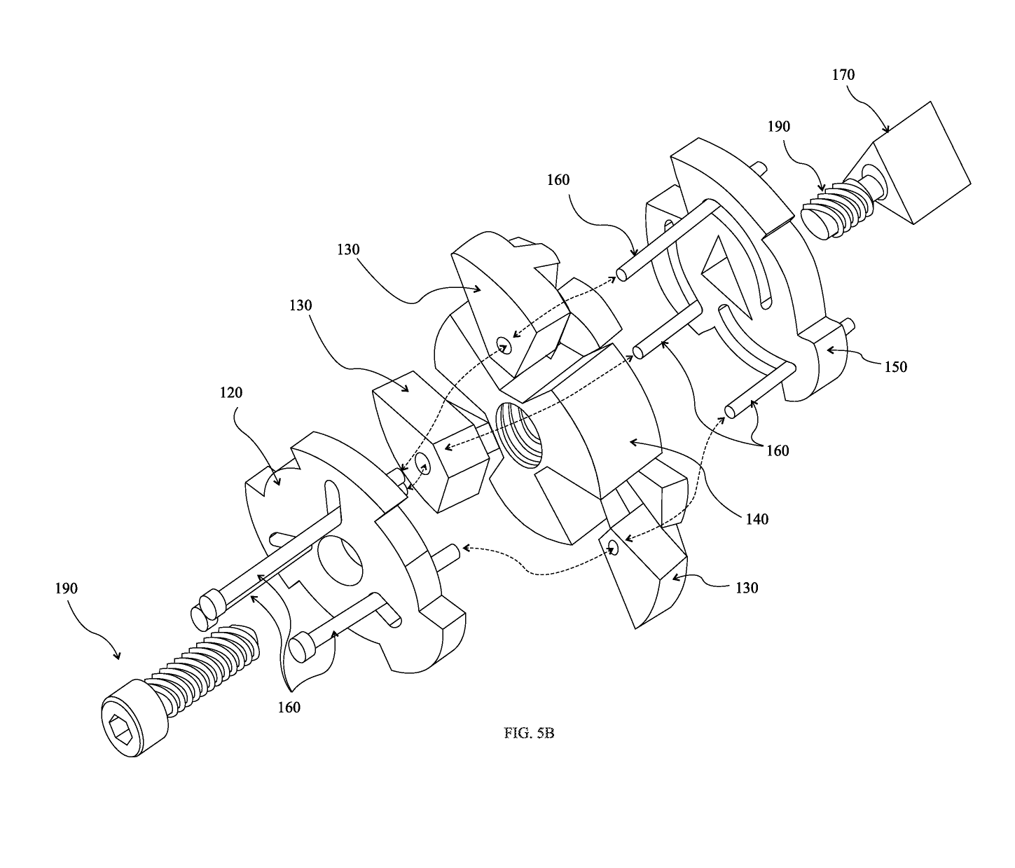

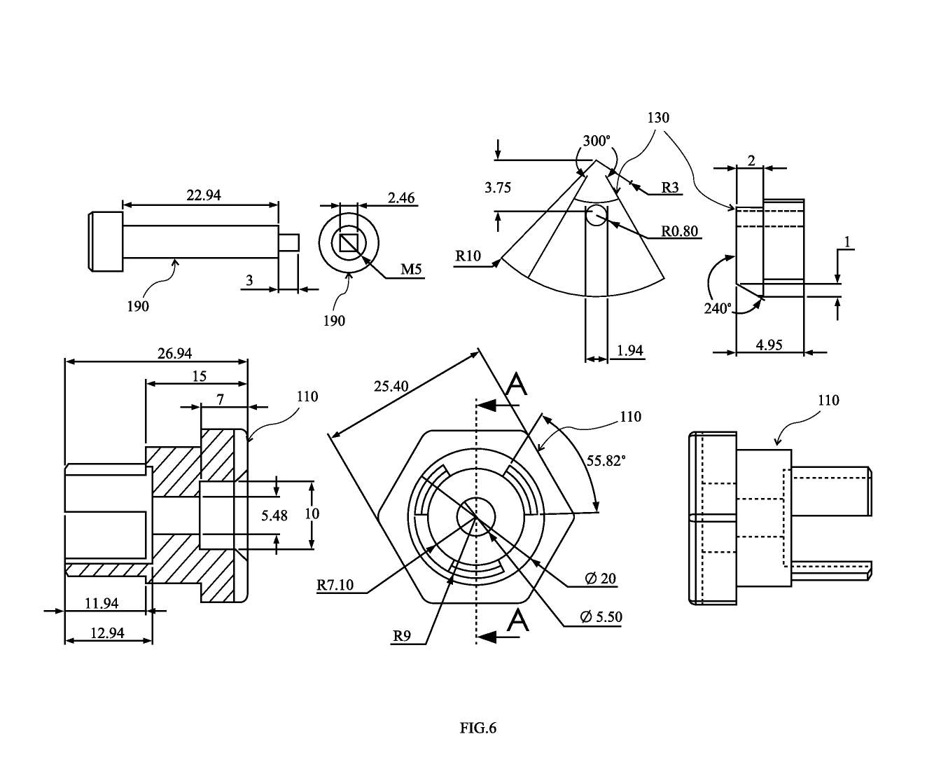

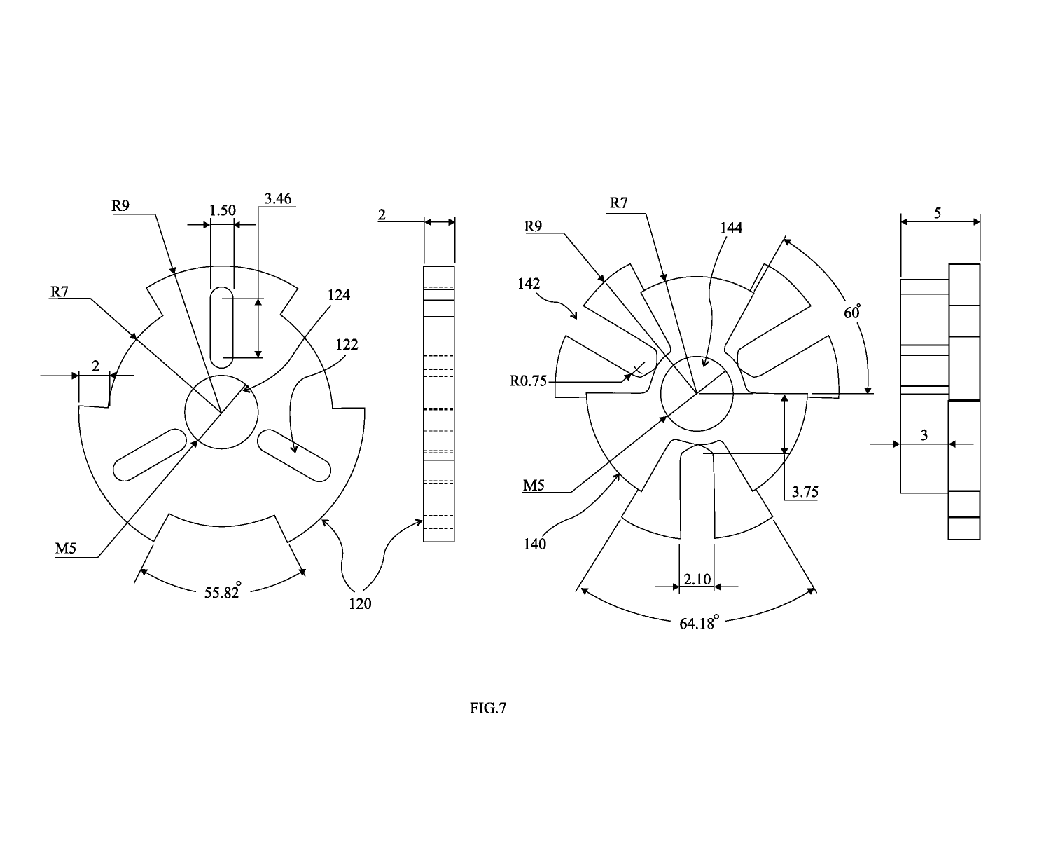

FIGS. 3A-10B provide various views of particular elements of a representative fastener 100 in accordance with an embodiment of the present disclosure. As best shown in FIG. 5A with further reference to FIG. 5B, the fastener 100 includes a main body 102 having a supporting, proximal, or upper portion, segment, member and/or a head 110, a plate top 120, at least one petal 130, a plate linear guide 140, a plate swirl guide 150, at least one retaining pin 160, a torque head 170, a distal or lower tip structure, element, or member (e.g., a cone tip) 180, and a rod 190. The rod 190 is configured for positioning parallel to or along portions of the fastener's main axis, for instance, within a set of central openings in the fastener's main body 102. In an embodiment, one or more portions of the rod 190, and particular corresponding openings into which the rod 190 can be disposed or inserted, can be threaded.

In several embodiments, the retaining pins 160 are configured to extend through curved slots 152 in the plate swirl guide 150, open-ended linear slots 142 in the plate linear guide 140, and closed-ended linear slots 122 in the plate top 120. The retaining pins 160 are additionally configured to couple to, mate with, and/or extend through openings in the petals 130. In the embodiment shown, the petals 130 are configured to be carried by the plate linear guide 140, between the plate swirl guide 150 and the plate top 120. In some embodiments, each petal 130 includes a projection or protruding member (e.g., on a distal, underside, or bottom side) configured for alignment or mating engagement with an open-ended linear slot 142 of the plate linear guide 140. When the petals 130 are carried by the plate linear guide 140 such that the underside projection of each petal 130 is aligned with a corresponding open-ended linear slot 142 of the plate linear guide 140, the openings in the petals 130 through which the pins 160 can extend are disposed toward or proximate to a central opening 144 in the plate linear guide.

The rod 190 is configured to extend through corresponding central openings 124, 144, 154 in the plate top 120, the plate linear guide 140, and the plate swirl guide 150, respectively. In an embodiment, the opening 124 in the plate top 120 can be threaded to facilitate or enable axial travel or motion of the rod 190 relative to the fastener's main axis. A lower end of the rod 190 is configured for coupling to the torque head 170. The torque head 170 is configured to matingly engage with or fit within an opening (e.g., a centrally disposed opening) 154 in the plate swirl guide 150.

In multiple embodiments, rotation of the rod 190 causes the torque head 170 to correspondingly rotate the plate swirl guide 150, thereby causing translation of the pins 160 carried by, coupled to, or extending through the plate swirl guide 150.

Simultaneous with the rotation plate swirl guide 150, the pins 160 are correspondingly displaced or guided along the open-ended linear slots 142 of the plate linear guide 140, in a direction transverse to the fastener's main axis (e.g., away from or toward the plate linear guide's central opening 144, depending upon the rod's direction of rotation), thereby transversely or radially displacing the petals 130 relative to (e.g., away from or toward) the fastener's main axis. The curved slots 152 in the plate swirl guide 150 are configured to facilitate or accommodate smooth or continuous lateral displacement of the pins 160 relative to the fastener's main axis as the plate swirl guide 150 rotates.

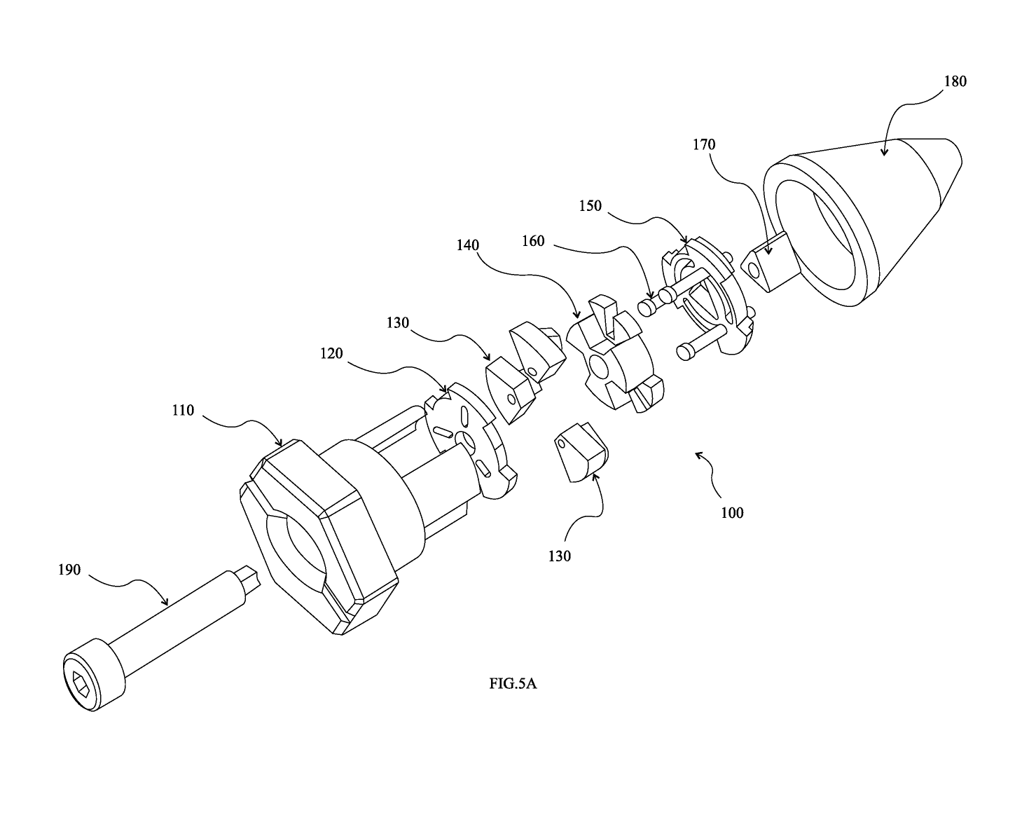

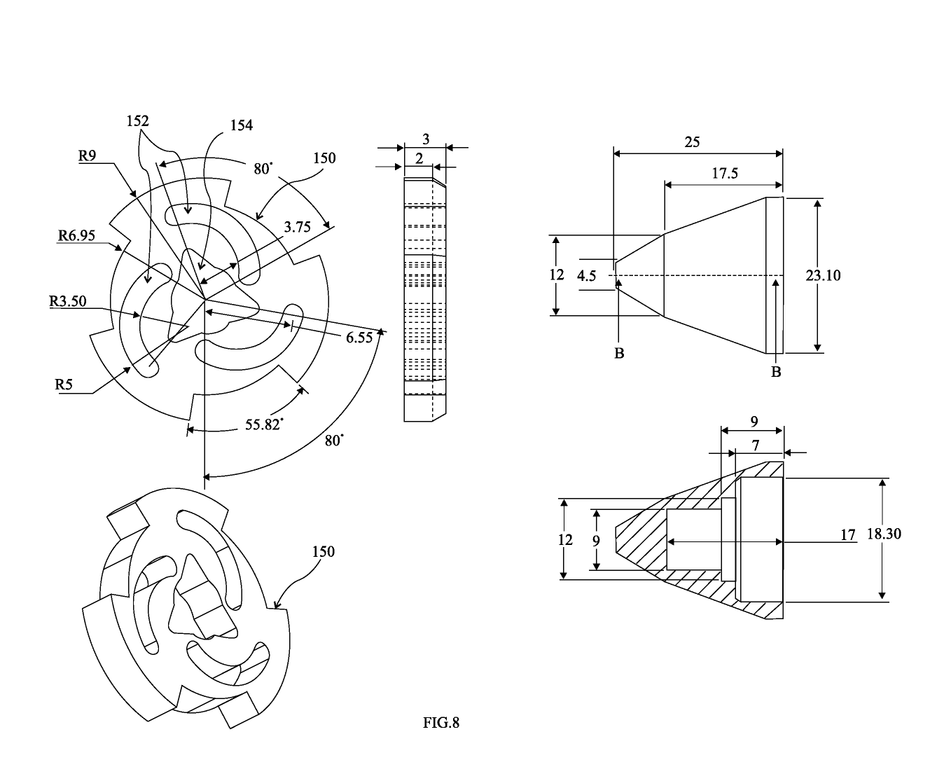

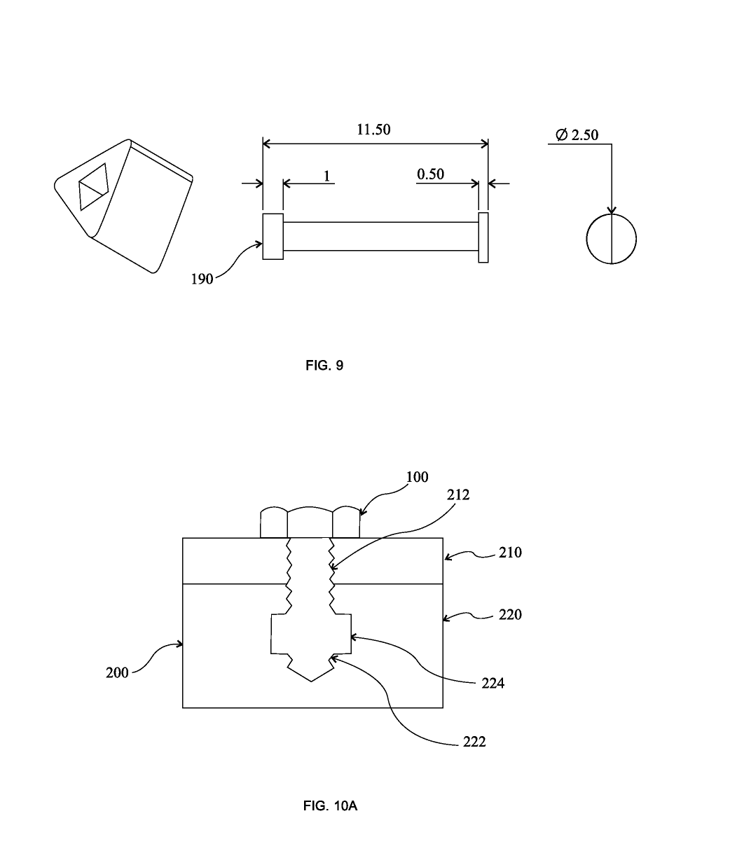

In some embodiments, the fastener 100 can have an outer threaded layer (not shown) which facilitates insertion into or through one or more objects, components, or tissues 210, 220 (e.g., FIGS. 10A-10B) to be held, retained, secured, or joined. In a closed position such as indicated by FIGS. 3A and 4A, the fastener 100 can be inserted or screwed into a hole 212, 222 in or through the object(s), component(s), or tissue(s) 210, 220. During and/or after insertion, rotational motion of the rod 190 (e.g., corresponding to manual, automated, or semi-automated rod turning) rotates the plate swirl guide 150 by way of the torque head 170. As the plate swirl guide 150 rotates, the retaining pins 160 force the petals 130 to move radially outward away from the fastener's main axis to thereby create or at least partially fill a corresponding opening 224 in the object(s), component(s), or tissue(s) 210, 220, thus facilitating or enabling the retention, securing, or joining of portions of the object(s), component(s), or tissue(s) 210, 220 together. Thus, rotational motion provided by or imparted to the rod 190 results in transverse or lateral motion of the petals 130 by way of (a) rotation of the plate swirl guide 150; and (b) linear displacement of the rods 160 and the petals 130 coupled thereto along open-ended linear slots 142 in the plate linear guide 140 in transverse petal displacement directions defined thereby, within a transverse petal displacement range or span defined or limited by the closed-ended linear slots 122 in the plate top 120. In a number of embodiments, additional force (e.g., rotational force or torque) can be provided or delivered to or placed on the rod 190 to provide a compression force between portions of the object(s), component(s), or tissue(s) 210, 220. Such torque can be applied until and after the torque head 170 disengages with the opening 154 in the plate swirl guide 150, which can result in axial motion or travel of the petals 130 in a direction parallel to the fastener's main axis, along or through an axial petal positioning range such as that indicated in FIG. 4A.

Prior to deployment, radial and/or axial displacement of one or more sets of petals 130 with respect to the fastener's main axis are reversible, for instance, depending upon a rotation direction of the rod 190 and a number of times the rod 190 is rotated. Depending upon embodiment details and/or a fastener application under consideration, following fastener deployment, radial and/or axial displacement of one or more sets of petals 130 can be reversible, restricted/avoided, or preventable.

Representative Fastener Applications

Fasteners in accordance with embodiments of the present disclosure can be adapted to or utilized in essentially any application, situation, environment, or industry in which reliable and effective holding, retaining, securing, or joining devices are desired or required, and/or a desire or need exists to create or at least partially fill holes having one or more deep or deeper large/larger cross-sectional areas or diameters relative to a shallow or shallower small/smaller cross-sectional area or diameter.

Consequently, fasteners in accordance with embodiments of the present disclosure can be adapted to or utilized in an extremely wide variety of applications, situations, environments, or industries, including but not limited to, for instance, applications associated with or involving household objects (e.g., wall and ceiling fasteners for paintings, toilet rails, lights, fan, door hinges, etc . . . ); furniture (e.g., cupboards, beds, cabinets, chairs, sofas, etc . . . ); architectural, construction, or civil engineering related structures or objects (e.g., reinforced or suspended members); electronic appliances (e.g., refrigerators, washing machines, televisions, etc . . . ); power tools (e.g., drill bits, motor, attachments to flexible shaft drilling devices, etc . . . ); automotive applications (e.g., wheel fasteners, engine mounting, etc . . . ); various types of equipment (e.g., operating lights, surgical beds, etc . . . ); geologic access (e.g., offshore drilling or mining); implantable medical devices (e.g., orthopedic implants such as spinal screws, hip stem, locking nails, etc . . . ); general instruments, including medical instruments (e.g., scissors, rongeurs, bone cutters, etc . . . ); fluid flow (e.g., check valves); sports (e.g., rock climbing); and many other applications.

For a given application under consideration, fasteners in accordance with embodiments of the present disclosure can be shaped or dimensioned based upon (a) a shape or dimension of one or more existing types of fasteners used in the application; and/or (b) application objectives, constraints, or requirements, in a manner readily understood by one of ordinary skill in the relevant art. Furthermore, portions of fasteners in accordance with embodiments of the present disclosure can be fabricated using a wide variety of materials, including but not limited to metals/metal alloys (e.g., stainless steel, titanium, aluminum, etc . . . ) and/or polymers (e.g., polyethylene, etc . . . ). The selection of particular material(s) from which the fastener is made can depend upon application objectives, constraints, or requirements, such as the properties of one or more environments, materials, components, or tissues in which the fastener is to be deployed (e.g., wood, concrete, metal/metal alloys, plastic, bone, etc . . . ); and/or whether the fastener is intended to be deployed on a transient, temporary/short term, lasting/long term, or permanent basis (e.g., in certain applications, one or more portions of a fastener in accordance with an embodiment of the present disclosure can include bio-degradable or bio-resorbable materials). The selection of particular types of fastener materials or material surfaces, textures, or contours can additionally be based upon whether ingress from an environment in which a fastener is disposed is desired, intended, or to be avoided. For instance, certain fastener embodiments in accordance with the present disclosure configured for deployment in bone tissue can include particular types of materials and/or material surface, texture, or contour characteristics (e.g., porosity or surface roughness) that facilitate bone tissue growth onto or into portions of the fastener.

The manufacture of a fastener in accordance with an embodiment of the present disclosure can involve manufacturing processes such as turning (e.g., by way of a lathe), milling, drilling, wire cutting, laser cutting, stamping, and/or molding/casting. The assembly of a fastener in accordance with an embodiment of the present disclosure can involve an assembly process that includes positioning or holding portions of the fastener (e.g., the main body) in a jig or fixture, and progressively or sequentially positioning particular fastener elements relative to each other while the fastener is retained by the jig.

With respect to a given fastener application, fasteners in accordance with particular embodiments of the present disclosure can provide significantly enhanced or additional performance and/or functionality relative to prior devices. For instance, compared to prior types of screws, bolts, or rivets, embodiments of fasteners configured as screws, bolts, or rivets in accordance with the present disclosure provide stronger pull-out strength, both in a blind or a through-hole application, without the use of excessive torque. Additionally, such fasteners also allow for a compression or a distraction force to be applied on two or more components of assembled parts when it is applied in a blind hole. Furthermore, such fasteners provide for fastening components together in a through-hole application where the back-end is impossible or difficult to access. Unlike a rivet which is a permanent mechanical fastener, fasteners in accordance with particular embodiments of the present disclosure can be applied or used and functions much like a rivet, and would exhibit similar strength, except that such fasteners in accordance with embodiments of the present disclosure can be removed without difficulty because radial displacement of petals can be bidirectional or reversible.

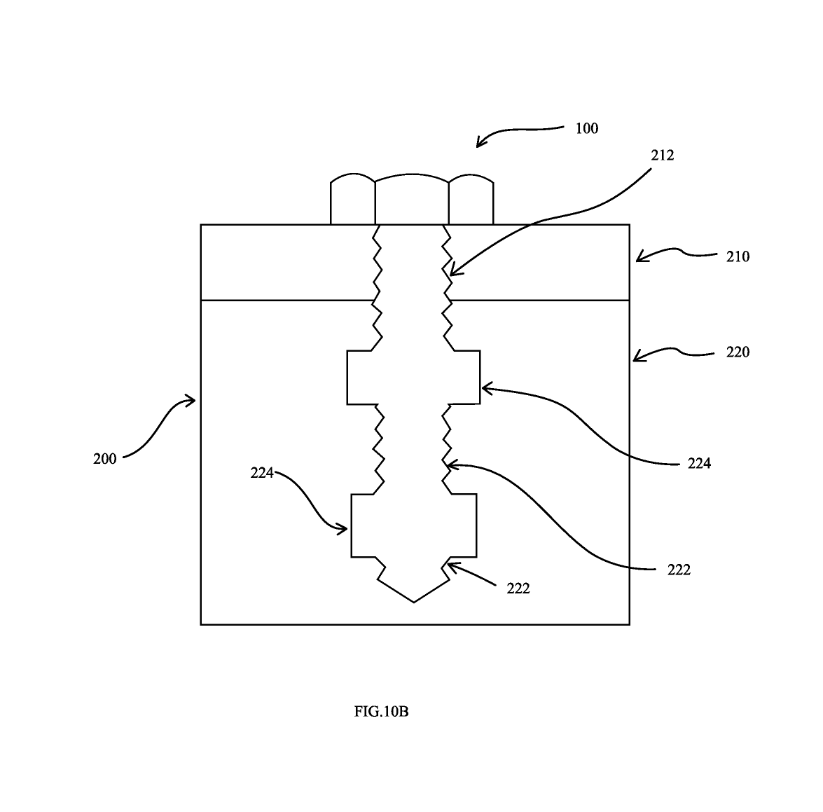

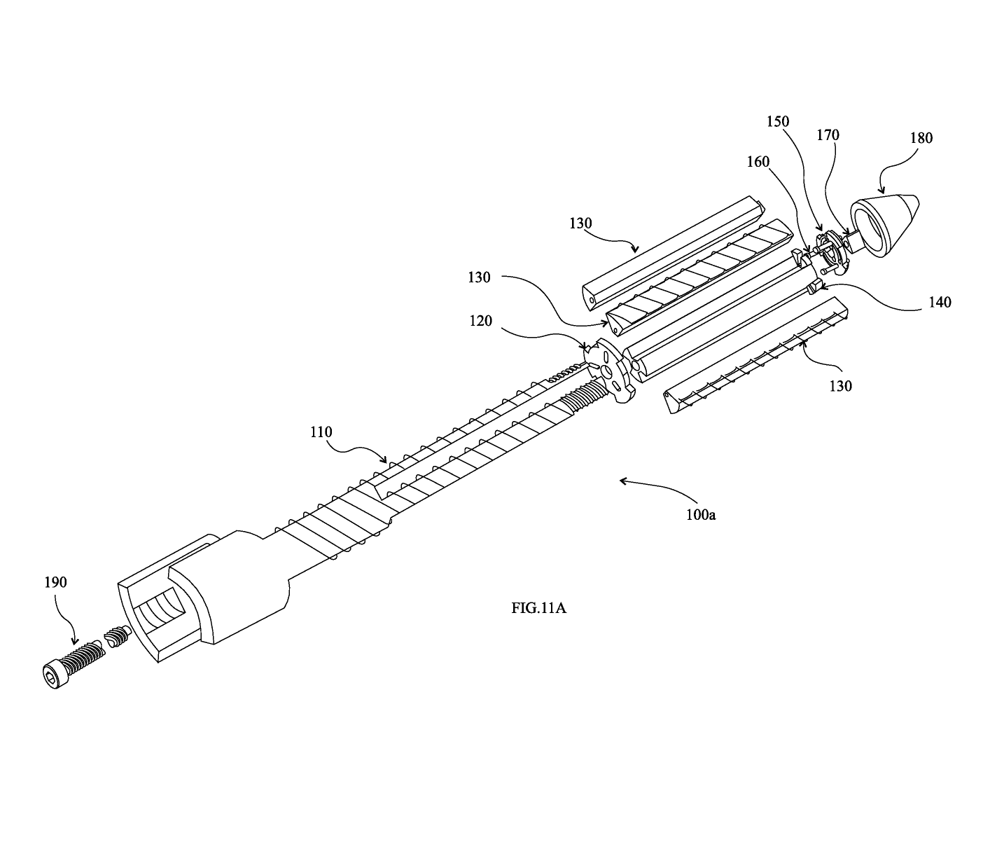

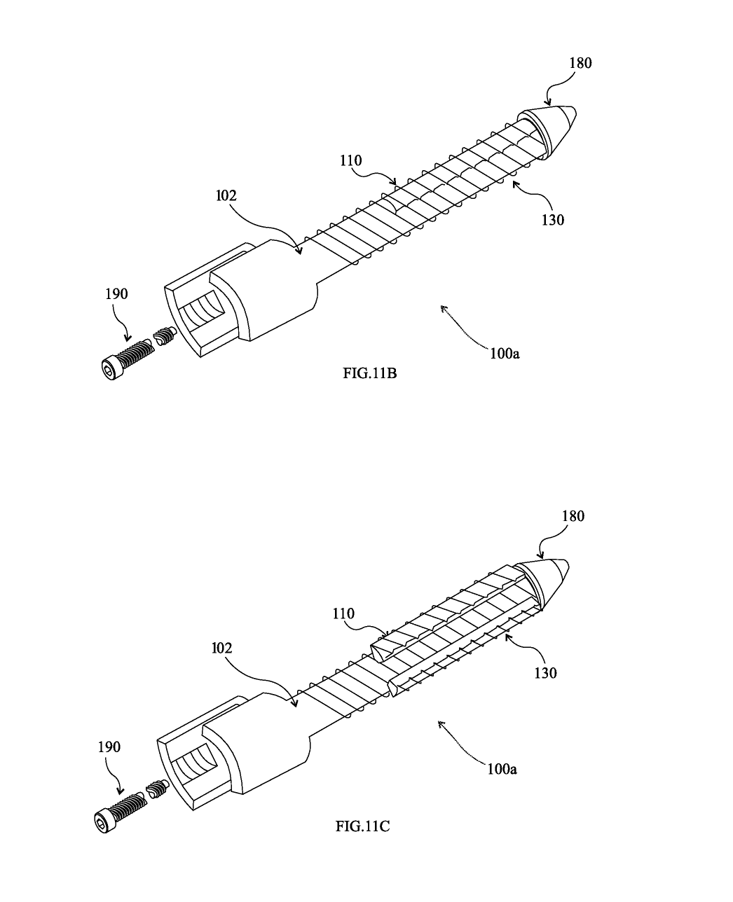

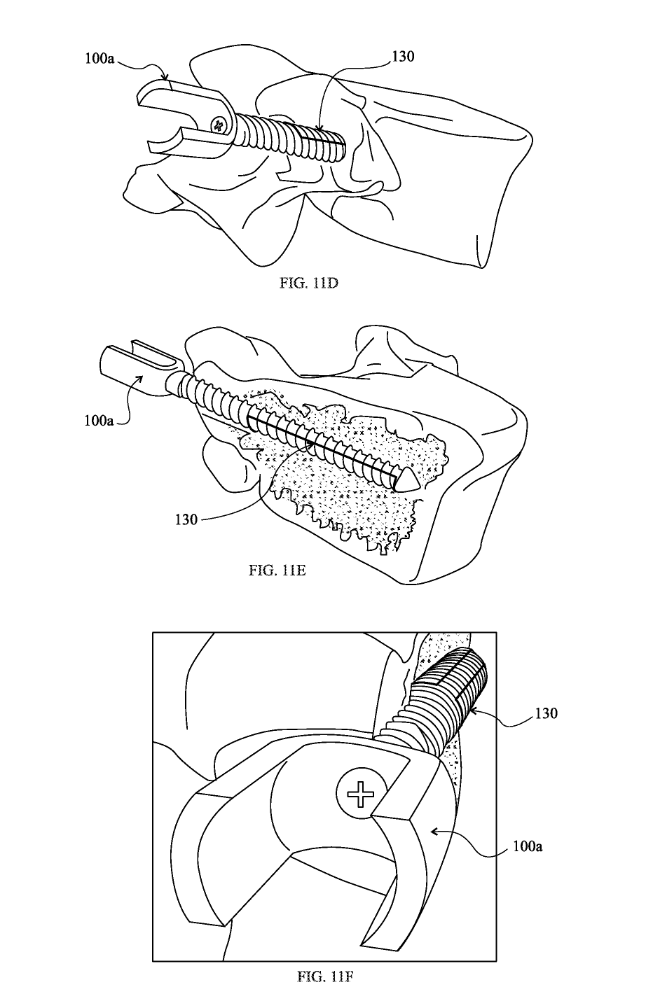

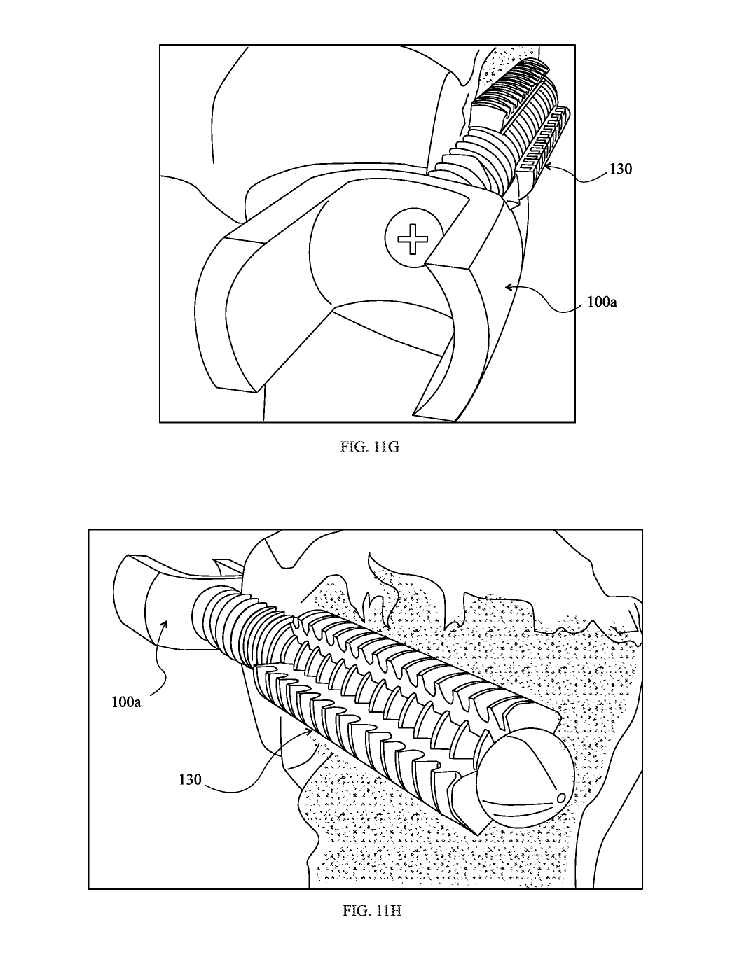

Representative fastener configurations suitable for particular non-limiting applications are described in detail hereafter with reference to FIGS. 11A-18.

FIG. 11A is a schematic illustration of a fastener configured as a pedicle screw 100a in accordance with an embodiment of the present disclosure. FIGS. 11B and 11C are schematic illustrations of the pedicle screw of FIG. 11A in an initial/unexpanded/non-deployed/closed position, and a final/expanded/deployed/secured/open position, respectively. In an embodiment, the pedicle screw 100a includes a main body 102 having a set of supporting members, elements, or arms 110 between which petals 130 can reside.

FIGS. 11D-11H are representative illustrations showing portions of a pedicle screw insertion and deployment process or procedure in accordance with an embodiment of the present disclosure. In such a procedure, a distal or terminal portion, end, or tip pedicle screw 100a in accordance with an embodiment of the present disclosure is inserted (e.g., drilled) into a vertebral pedicle to a desired, target, or final depth, with the pedicle screw's petals 130 carried, disposed, or maintained in an undeployed position. Once the pedicle screw 100a has been inserted to its desired, target, or final depth within the vertebral pedicle, turning a screw head or other mechanism to rotate a rod 190 internal to the pedicle screw 100a causes displacement or expansion of the petals 130 beyond the transverse or cross-sectional extent of main body 102 into the vertebral pedicle, thereby securing the pedicle screw 100a in position.

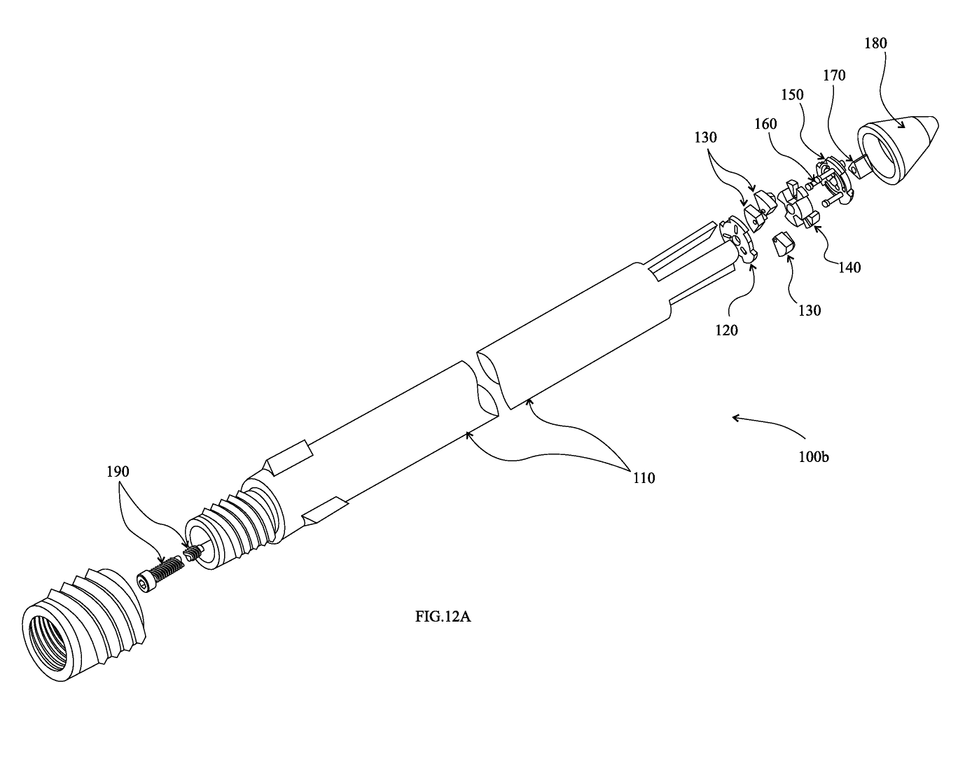

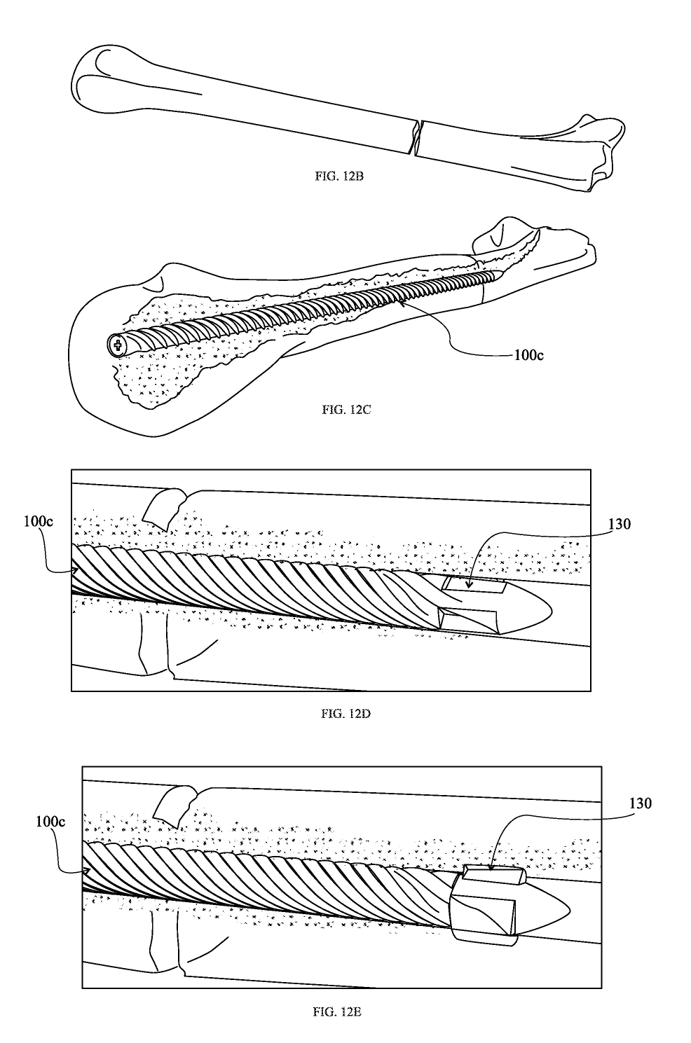

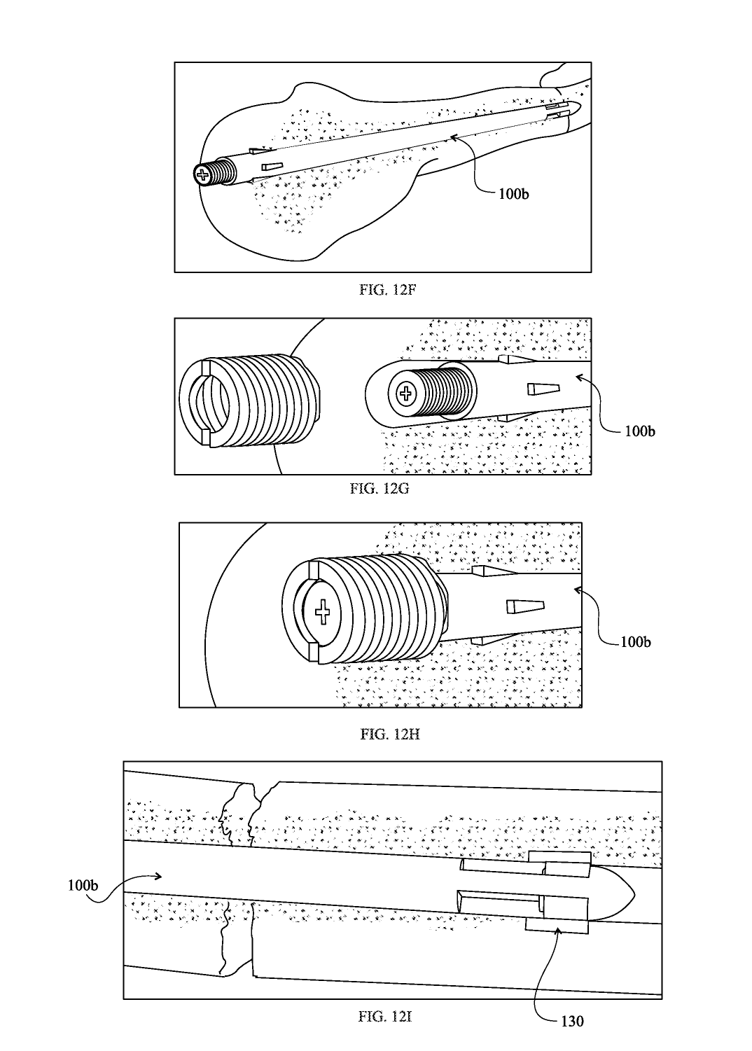

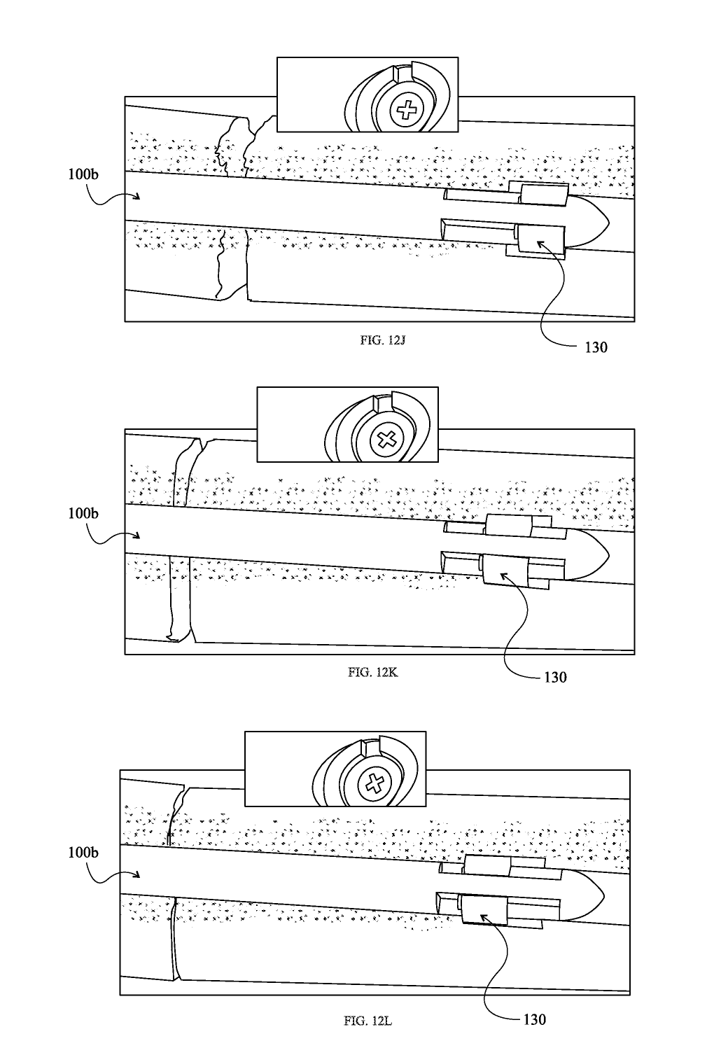

FIG. 12A is a schematic illustration of a fastener configured as an intramedullary nail or rod 100b in accordance with an embodiment of the present disclosure. FIGS. 12B-12L are representative illustrations showing an intramedullary nail insertion and deployment process or procedure in accordance with an embodiment of the present disclosure. In association with the intramedullary nail insertion and deployment process directed to joining segments or sections of a long bone such as two bone segments shown in FIG. 12A, an intramedullary reamer or tunneling tool 100c of a type shown in FIGS. 12C-12E can be inserted into the bone (e.g., by way of drilling) to a desired, target, or final intramedullary tunnel or channel depth to create an intramedullary tunne or channel having a first diameter. The intramedullary tunneling tool 100c includes a set of petals 130 disposed proximate to a distal end.

Upon reaching the target or final intramedullary tunnel depth, the petals 130 can be radially displaced or expanded away from the tunneling tool's main body 102 to define a cross-sectional area greater than a diameter corresponding to the main body of the intramedullary tunneling tool 100c. The intramedullary tunneling tool 100c and its petals 130 can be rotated (e.g., by a drill motor) and displaced along a given distance of the tunnel (e.g., along a portion of the tunnel's terminal section or end) such that the rotation of the tunneling tool's expanded petals 130 creates and an augmented or expanded diameter portion or segment of the intramedullary tunnel. Depending upon embodiment details, the intramedullary tunneling tool's petals 130 can be laterally or radially displaced concurrent with or separate from rotational motion of the tunneling tool's main body. The intramedullary tunneling tool's petals 130c can subsequently be returned to an undeployed, non-expanded, withdrawn, or retracted position (e.g., flush or substantially flush with the main body 102), and the intramedullary tunneling tool 100c can be withdrawn from the bone segments. Thus, by way of the intramedullary tunneling tool 100c, an intramedullary tunnel or channel can be created which exhibits at least two distinct diameters, including a second diameter toward and/or at a distal end of the intramedullary tunnel, which is larger than a first diameter along diameter along a main extent or primary portion of the intramedullary tunnel's depth.

Next, the intramedullary nail or rod 100b can be inserted into the intramedullary tunnel in a manner indicated in FIGS. 12G-12I, such that the intramedullary nail's petals 130 reside within the augmented or expanded diameter segment of the intramedullary tunnel. The intramedullary nail's petals 130 can be radially displaced to at least substantially extend to the internal boundaries of the intramedullary tunnel's expanded diameter segment in a manner indicated in FIG. 12J. The intramedullary nail's petals 130 can then be axially displaced or shifted toward an externally accessible or proximal end of the intramedullary nail 100b. Such axial displacement of the petals 130 correspondingly causes displacement of the bone segment in which the petals 130 reside toward and to the other bone segment, in a manner indicated in FIGS. 12K and 12L, thereby reducing, essentially eliminating, or closing a gap between or joining the bone segments.

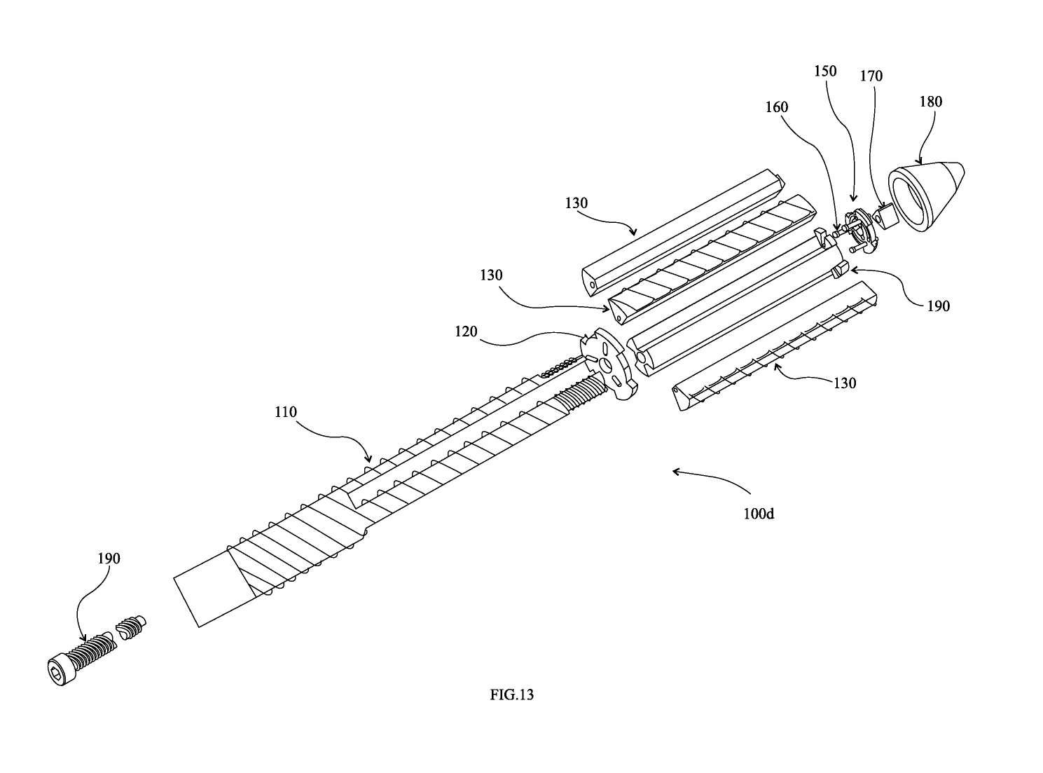

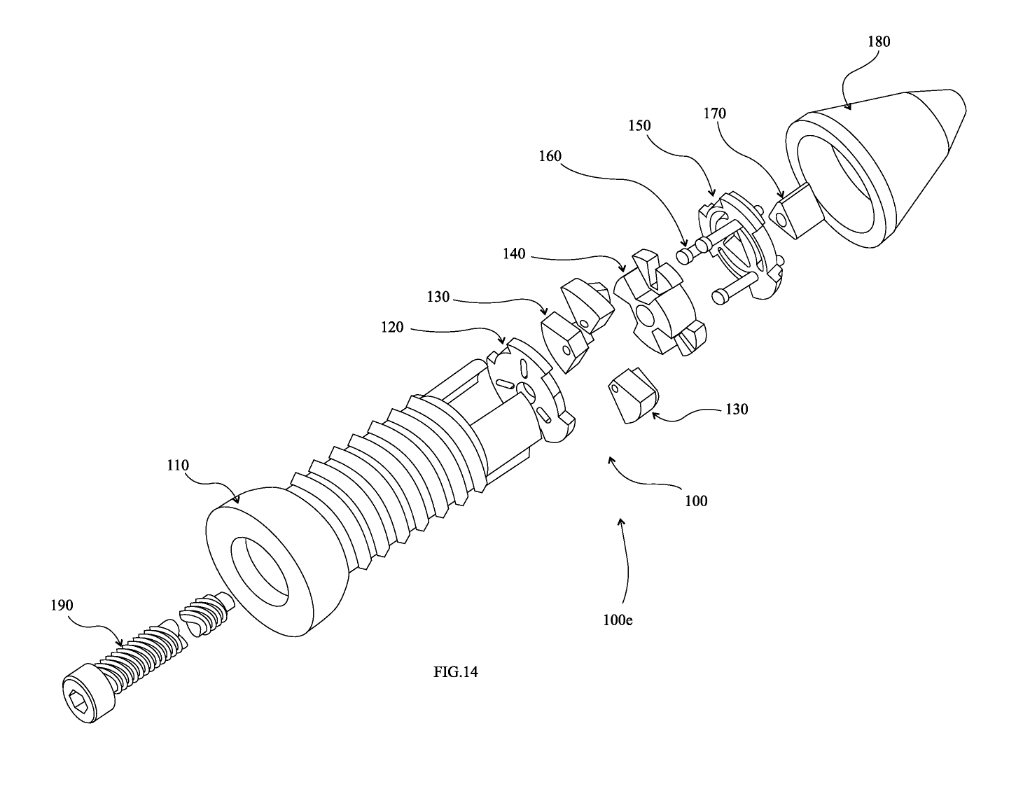

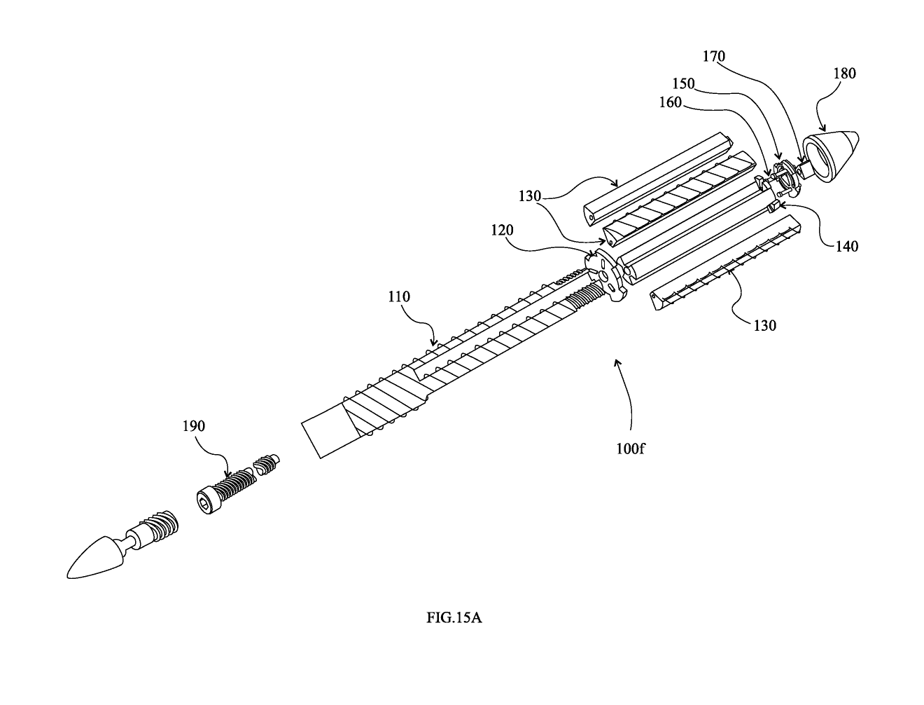

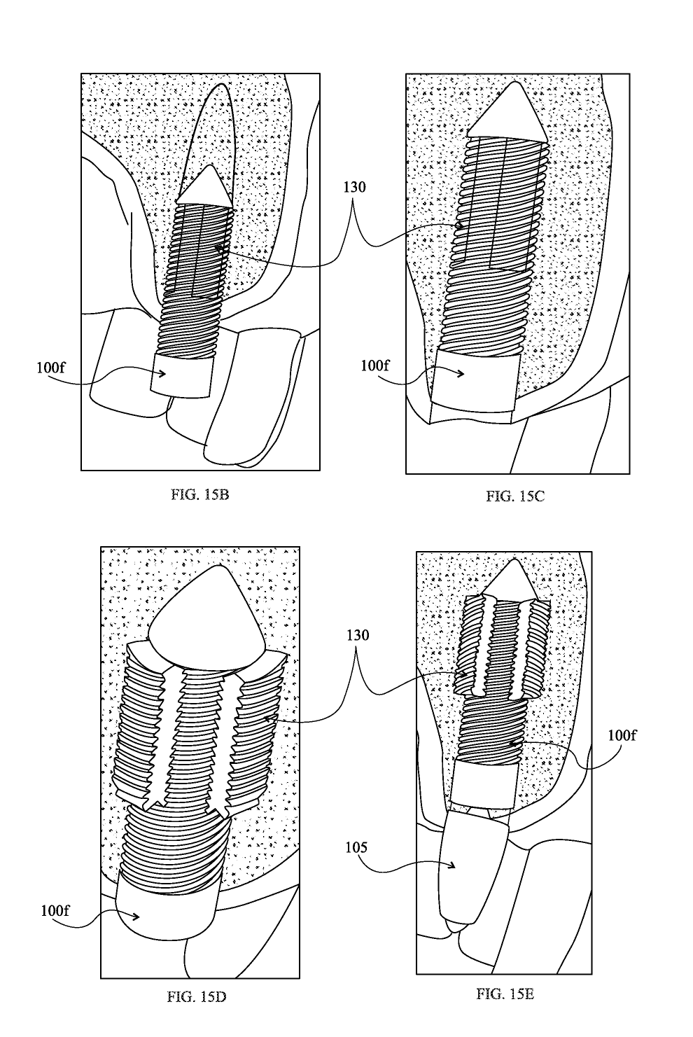

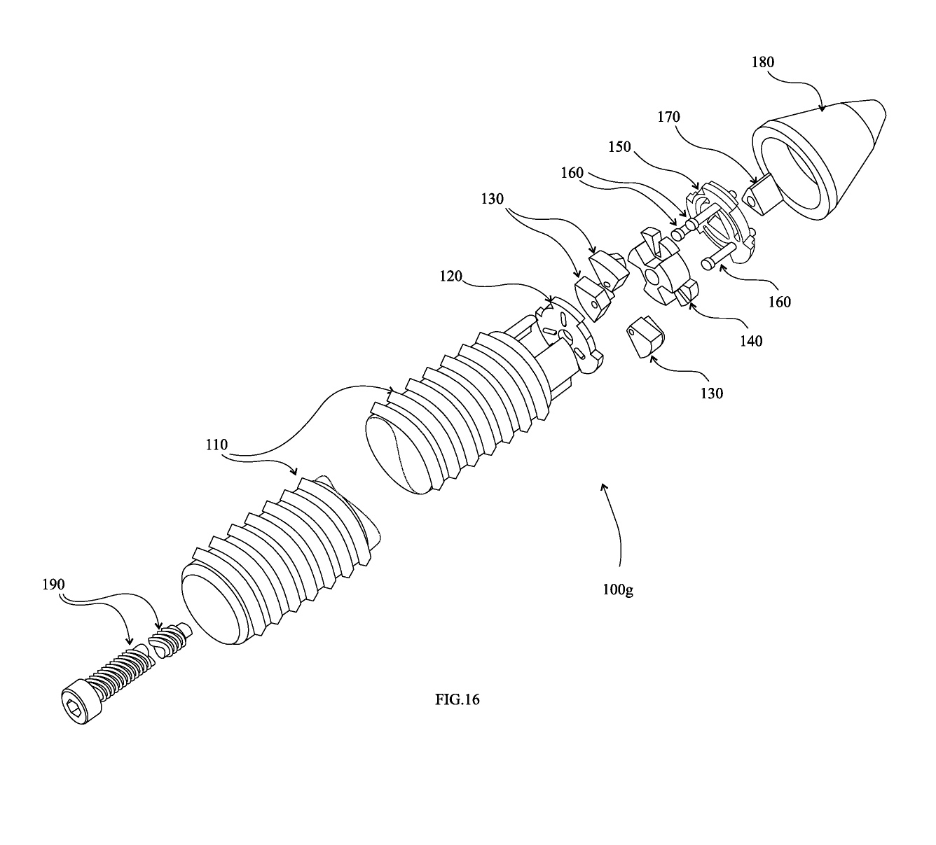

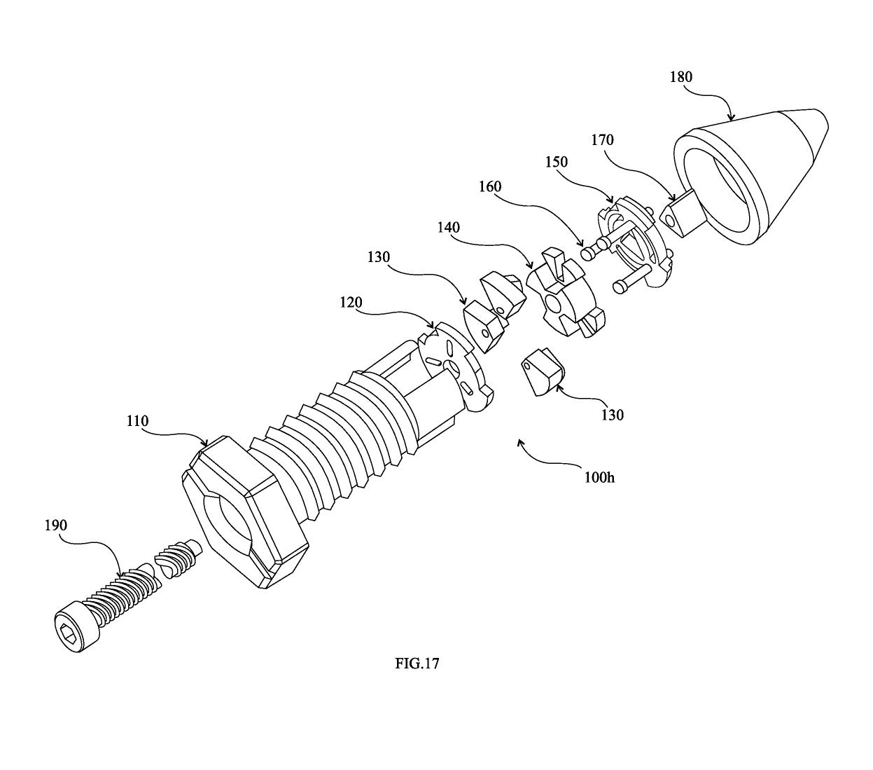

Fastener embodiments in accordance with the present disclosure can further be configured for a variety of other medical applications. For instance, FIG. 13 is a schematic illustration of a fastener configured as an interference screw 100d in accordance with an embodiment of the present disclosure; and FIG. 14 is a schematic illustration of a fastener configured as a dynamic hip screw 100e in accordance with an embodiment of the present disclosure. Additionally, FIG. 15A is a schematic illustration of a fastener configured as a dental implant 100f in accordance with an embodiment of the present disclosure. FIGS. 15B-15E are representative illustrations showing a dental implant insertion and deployment process in accordance with an embodiment of the present disclosure. In association with a dental implant insertion and deployment process, a dental implant 100f is drilled or screwed to a target endosseus depth (e.g., at a location corresponding to a tooth extraction) in a manner indicated in FIGS. 15B and 15C. Next, petals 130 carried by the dental implant 100f are radially expanded into bone tissue in a manner indicated in FIG. 15D to thereby secure or anchor the dental implant 100f in the bone tissue. Subsequently, a dental implant interface element 105 can be coupled to (e.g., screwed onto or into) the dental implant 100f to facilitate mounting of an artificial tooth thereto.

As indicated above, fastener embodiments in accordance with the present disclosure can be configured to satisfy the requirements of a multitude of mechanical or tool applications. For instance, FIG. 16 is a schematic illustration of a fastener configured as a drill bit/reamer or a boring/tunneling tool 100g in accordance with an embodiment of the present disclosure; and FIG. 17 is a schematic illustration of a fastener configured as a screw 100h in accordance with an embodiment of the present disclosure.

Representative Structural and/or Functional Fastener Configuration Variations

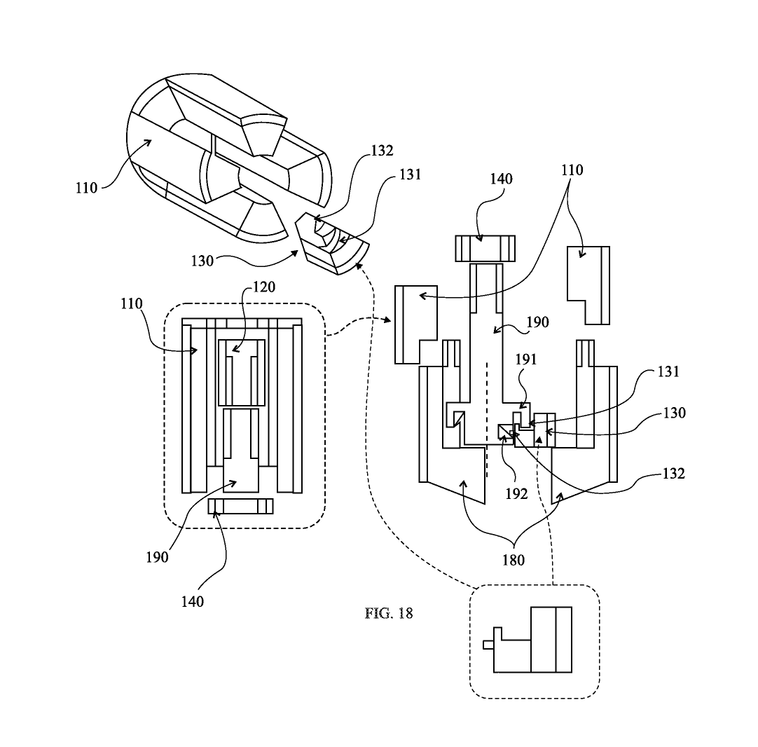

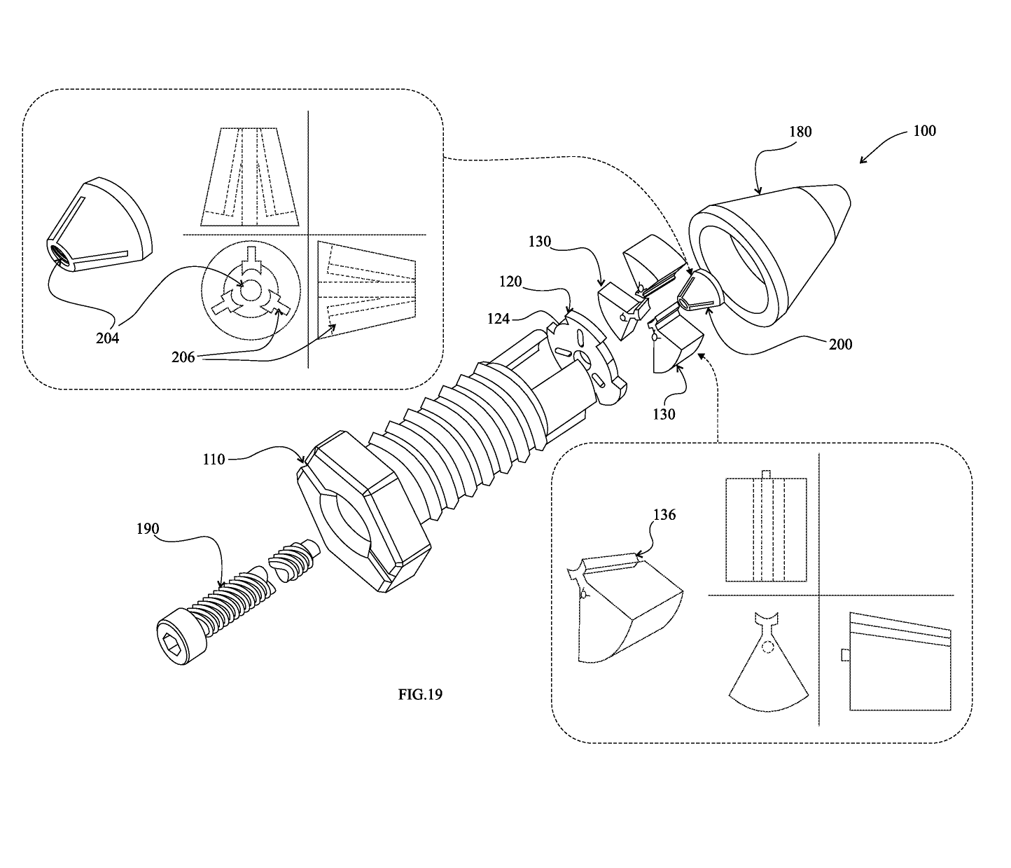

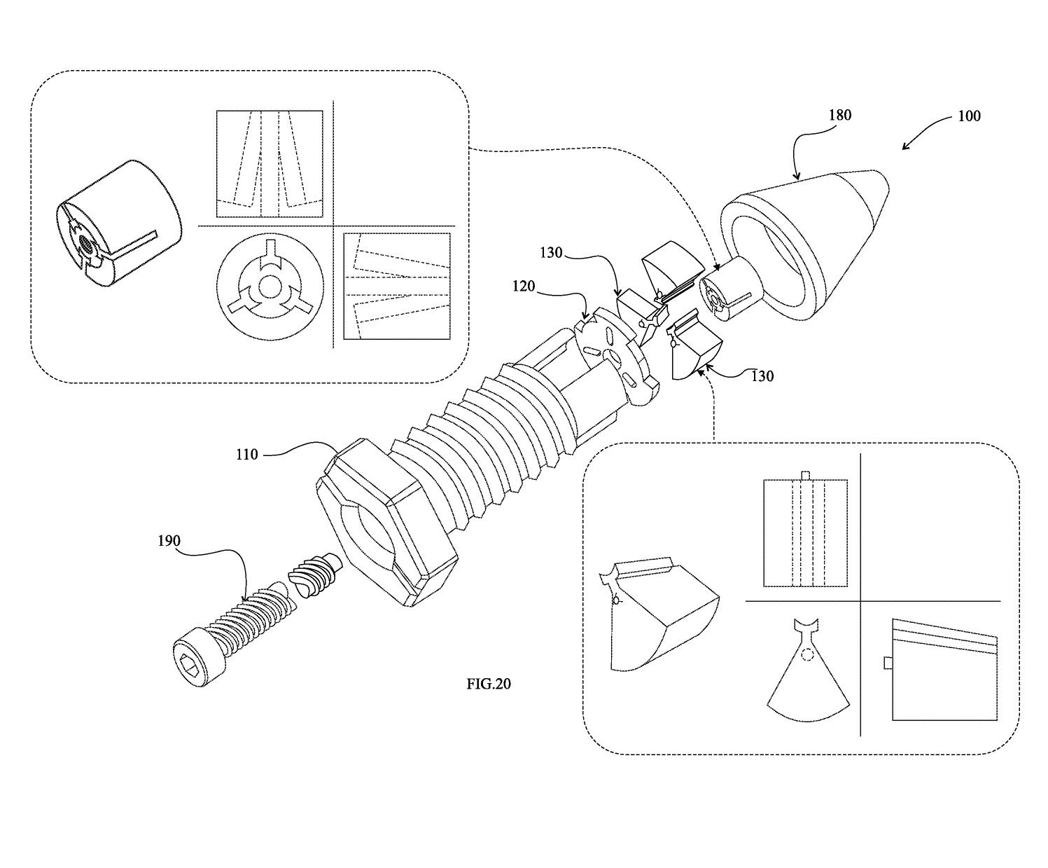

Particular fastener elements can exhibit structural variations relative to structural fastener aspects described above, which can provide identical, substantially identical, and/or augmented functionality relative to functional fastener aspects described above. Representative non-limiting types of fastener configuration variations are provided hereafter with reference to FIGS. 18-23.

FIG. 18 is a schematic illustration of a fastener cam mechanism or assembly that includes a set of rails in accordance with an embodiment of the present disclosure. In an embodiment, a petal 130 includes a first portion or element 131 that facilitates or enables transverse or radial petal displacement by way of engagement with a corresponding first portion or element 191 of a central member or rod 190, and a second portion or element 132 that facilitates or enables axial petal displacement by of engagement with a corresponding second portion or element 192 of the rod 190. The rod 190 and petals 130 coupled thereto are disposed within a core or central region of a main body 102. A plate 140 limits or restricts axial displacement of the rod 190 relative to the main body 110.

FIG. 19 is a schematic illustration of a fastener 100 that includes an inverted cone and rail mechanism for engaging and displacing petals in accordance with an embodiment of the present disclosure, and FIG. 20 is a schematic illustration of a fastener 100 that includes a cylinder and sloped rail mechanism for engaging and displacing petals in accordance with an embodiment of the present disclosure. As shown in FIGS. 19 and 20, the fastener 100 includes a head 110, a plate top 120, a plurality of petals 130, an inverted cone or round cylinder 200, a head member (e.g., a cone tip) 180, and a rod 190. In an embodiment, the rod 190 can be threaded.

In operation, the rod 190 extends through corresponding central openings 124, 204 (threaded), respectively. A mail railing 136 of a given petal 130 can slide through a female railing 206 of the inverted cone 200. When the rod 190 is turned in one direction, the upward movement of the inverted cone 200 towards the head 100 causes the radial expansion or displacement of the petals 130 due to an outward push of the male and female railings 136, 206. After complete expansion of the petals 130, further turning of the rod 190 can cause axial movement of the petals 130 in the direction of the head 100.

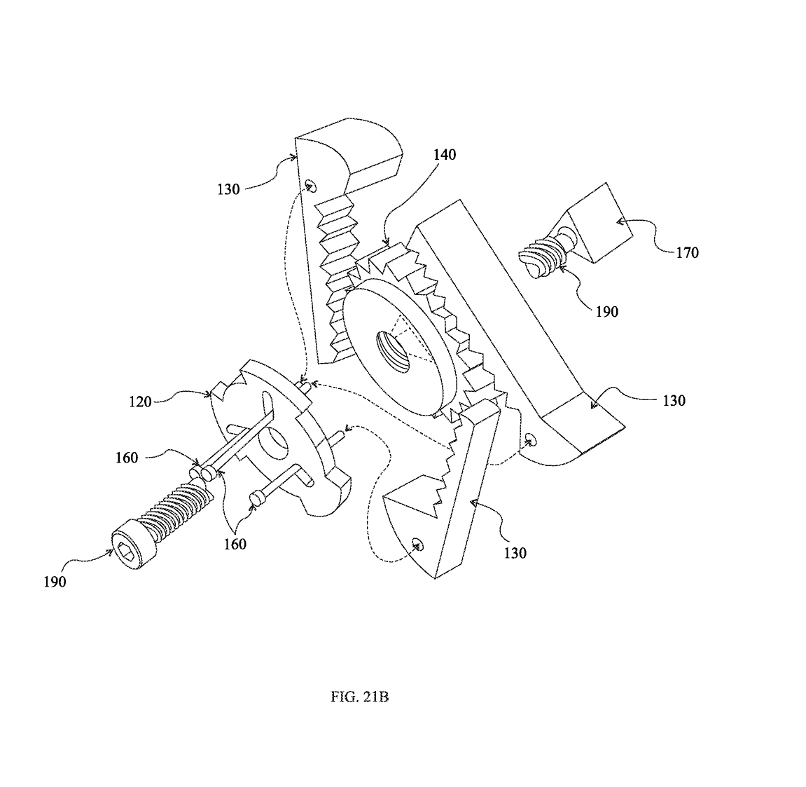

FIG. 21A is a schematic illustration of a fastener 100 that includes a radial and axial petal positioning mechanism in accordance with another embodiment of the present disclosure, and FIG. 21 B is a schematic illustration further detailing portions of the fastener of FIG. 21A. In an embodiment, the fastener 100 includes a head 110, a plate top 120, a plurality of petals 130, a torque head 170, a cone tip 180, a rod 190, and a gear plate 200. In an embodiment, the rod 190 can be threaded.

In operation, the rod 190 extends through corresponding central openings 124, 204, in the plate top 120 and the gear plate 200, respectively. A lower end of the rod 190 is coupled to the torque head 170. The torque head 170 is configured to fit within an opening 204 in the gear plate 200. In some embodiments, the fastener 100 includes an outer threaded layer (as shown) which facilitates or effectuates insertion into one or more objects, components, or tissues. Once inserted, turning the rod 190 rotates the gear plate 200 by way of the torque head 170. As the gear plate 200 rotates, it forces the petals 130 to move radially outward by way of gear motion. Further torque can be applied until the torque head 170 disengages with the opening 204 in the gear plate 200, which then allows the petals 130 to move axially along the body, shaft, or shank of the fastener toward the head 110.

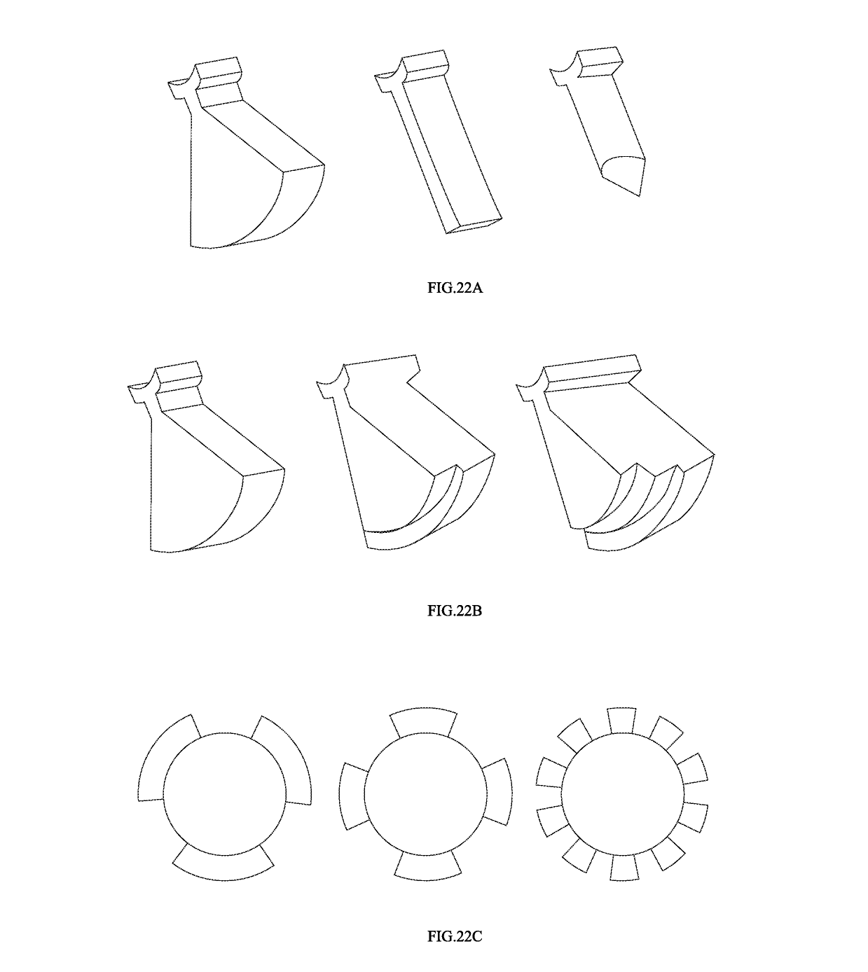

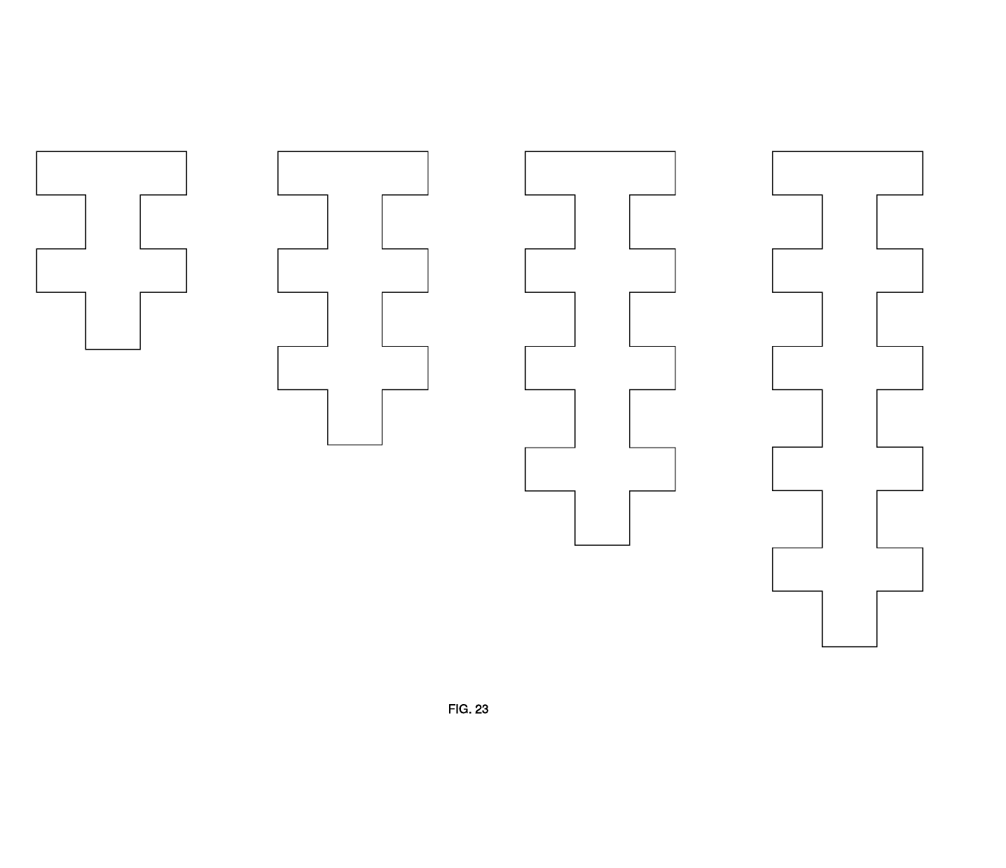

Petals 130 themselves can exhibit a number of different configurations, depending upon fastener application or embodiment details. For instance, FIGS. 22A-22C are schematic illustrations of various representative petal configurations in accordance with particular embodiments of the present disclosure; and FIG. 23 is an illustration of various representative main body/shaft and petal configurations in accordance with particular embodiments of the present disclosure. As indicated in FIG. 22A, individual petals 130 can exhibit a variety of shapes, sizes, surface areas, and/or contours. Furthermore, a petal 130 can be a single-tier or multi-tiered structure as indicated in FIG. 22B. A petal 130 can exhibit a smooth exterior profile, or a tapered or rough exterior profile (e.g., which is capable of cutting or fluting). The number(s), shape(s), size(s), and/or spatial distribution of individual petals 130 relative to a fastener's main body can vary in multiple manners in accordance with embodiment details and/or fastener application objectives or requirements, such as in particular manners indicated in FIG. 22C.

As indicated in FIG. 23, a given fastener design can include one or multiple sets of petals 130 disposed along the length of the fastener's main body 102. Each set of petals 130 is radially or outwardly displaceable relative to the main body, and in some embodiments, one or more sets of petals 130 can be axially displaceable along particular portions of the main body's length. Any given set of petals 130 can be radially displaced or expanded in a manner that defines or provides a cross-sectional area or diameter that is greater than a cross-sectional area or diameter defined or provided by the main body. Depending upon embodiment details, the cross-sectional area or diameter defined or provided by a given set of petals 130 can be identical to or different from (e.g., larger or smaller than) the cross-sectional area or diameter defined or provided by another set of petals 130 carried by the same fastener.

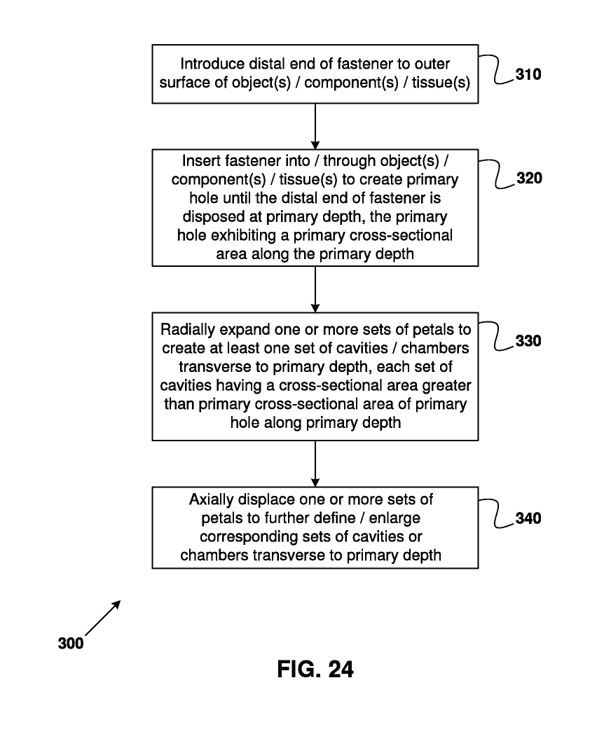

FIG. 24 is a flow diagram of a representative hole creation and/or fastener insertion process 300 in accordance with an embodiment of the present disclosure. In an embodiment, the process 300 involves a first process portion 310 in which a distal end or terminal portion of a fastener 100 having a main body 102 defining or providing a first cross-sectional area or diameter is brought in contact with or partially inserted into a surface corresponding to a set of objects, components, or tissues in which a hole is to be created and/or the fastener 100 is to be disposed.

A second process portion 320 involves insertion of the fastener's distal end and portions of the main body 102 into and through portions of the set of objects, components, or tissues, such that (a) the fastener's distal tip and/or one or more sets of petals 130 carried by the fastener 100 are disposed relative to a desired, intended, target, final, or primary depth within the set of objects, components, or tissues; and (b) the fastener 100 has correspondingly created an initial or primary hole having a primary cross-sectional area or diameter corresponding to or mated with the first cross-sectional area or diameter. The second process portion 320 can involve the application of penetrating longitudinal displacement forces along the fastener's length into the set of objects, components, or tissues, as well as rotational forces or torques relative to the fastener's main axis (e.g., provided by drill-type motion of the fastener 100).

A third process portion 330 involves radially expanding one or more sets of petals 130 away from the main body 102 in a simultaneous or sequential manner while the fastener 100 is disposed in the primary hole, thereby at least partially creating a cavity or chamber corresponding to each expanding or expanded set of petals 130. Each such cavity or chamber extends laterally or radially away from the primary hole at a particular location or interval along the primary depth. In some embodiments, the third process portion 330 involves the application of rotational forces or torques to the fastener 100, such that the expanding or expanded petals 130 are rotated about the fastener's main axis (e.g., simultaneous with rotation of the fastener's main body 102) to facilitate or effectuate the creation of one or more lateral cavities or chambers. Along the primary depth, any given lateral cavity or chamber defines an additional cross-sectional area or diameter with respect to the primary cross-sectional area or diameter, which is larger than the first cross-sectional area or diameter and the primary cross-sectional area or diameter. Lateral cavities or chambers created by different sets of petals 130 disposed along the fastener's length can exhibit identical or different cross-sectional areas or diameters.

Once each set of petals 130 under consideration has been radially expanded to create a lateral cavity or chamber providing a desired, intended, target, or final cross-sectional area larger than the first cross-sectional area and the primary cross-sectional area, in some embodiments a fourth process portion 340 involves axially displacing one or more sets of petals 130 relative to the fastener's main axis. In a number of embodiments, the fourth process portion 340 can be performed in association with the third process portion 330 to expand or enlarge the spatial extent or size of one or more lateral chambers or cavities. Lateral cavities or chambers disposed along different locations or intervals of the primary hole's depth (e.g., which were created by different sets of petals 130 disposed along the fastener's length) can exhibit identical or different spatial volumes (e.g., depending upon one or more petal thicknesses along a direction parallel to the fastener's main axis).

The first through fourth process portions 310-340 result in the creation of a hole having multiple cross-sectional areas or diameters associated therewith relative to the hole's depth. Following the fourth process portion 340, the fastener 100 can remain deployed in the hole, or the fastener 100 can be removed or withdrawn from the hole. In certain applications in which the fastener 100 is removed from the hole, the hole can be at least partially filled with a fluid or liquid (e.g., a liquid that can assume the volumetric or spatial profile defined by one or more portions of the hole, and which may further harden or solidify).

Aspects of particular embodiments of the present disclosure address at least one aspect, problem, limitation, and/or disadvantage associated with existing penetrating, boring, restraining, retaining, joining, securing, gripping, clamping, fastening, and/or locking systems, apparatuses, mechanisms, devices and techniques. While features, aspects, and/or advantages associated with certain embodiments have been described in the disclosure, such embodiments are to be considered in all respects to be illustrative and not restrictive, as other embodiments may also exhibit such features, aspects, and/or advantages, and not all embodiments need necessarily exhibit such features, aspects, and/or advantages to fall within the scope of the disclosure. It will be appreciated by a person of ordinary skill in the art that particular features, aspects, and/or advantages of one or more of the above-disclosed embodiments can be desirably combined into other different systems, apparatuses, mechanisms, or devices and/or utilized in other applications. In addition, various modifications, alterations, and/or improvements to disclosed embodiments that remain within the scope and spirit of the present disclosure may be made by a person having ordinary skill in the relevant art.

1. A device configured for at least one of a penetrating into, boring into, restraining, retaining, joining, securing, gripping, clamping, fastening, and locking portions of a set of objects, components, or tissues, the device comprising:
a main body having a length parallel to a main axis definable through the main body, the main body having a first cross-sectional area transverse to the main axis; and
a first set of petals carried by the main body and comprising at least one petal, the first set of petals selectively displaceable about the main axis in a direction transverse to the main axis in the substantial absence of axial displacement of the first set of petals in a direction parallel to the main axis, each petal within the first set of petals displaceable between a first position and a second position transverse to the main axis, the first position closer to the main axis than the second position.

2. The device of claim 1, wherein the first position corresponds to a retracted position in which the first set of petals is disposed at least substantially within the first cross-sectional area and the second position corresponds to an extended position in which the first set of petals is disposed beyond the first cross-sectional area in a manner that defines a second cross-sectional area larger than the first cross-sectional area.

3. The device of claim 2, wherein the second position corresponds to a transverse petal displacement range that defines a maximum lateral distance across which the first set of petals is displaceable relative to the main axis.

4. The device of claim 3, wherein each petal within the first set of petals is incrementally displaceable along the transverse petal displacement range.

5. The device of claim 1, wherein each petal within the first set of petals is simultaneously displaceable between the first position and the second position.

6. The device of claim 1, wherein the first set of petals includes at least two petals, each of the at least two petals having a corresponding transverse cross section disposed parallel to a petal displacement plane defined perpendicular to the main axis.

7. The device of claim 1, wherein the first set of petals is further selectively axially displaceable along a direction parallel to the main axis.

8. The device of claim 7, wherein the device is configured for transverse displacement of the set of petals relative to the main axis separate from axial displacement of the set of petals relative to the main axis.

9. The device of claim 1, further comprising a second set of petals carried by the main body and comprising at least one petal, the second set of petals selectively displaceable about the main axis in a direction transverse to the main axis, each petal within the second set of petals displaceable between the first position and at least one of the second position and a third position transverse to the main axis, the third position farther from the main axis than each of the first position and the second position.

10. The device of claim 9, wherein the first and second sets of petals are configured for simultaneous lateral displacement relative to the main axis.

11. The device of claim 9, wherein at least one of the first set of petals and the second set of petals is further configured for axial displacement in a direction parallel to the main axis.

12. The device of claim 11, wherein at least one of the first set of petals and the second set of petals is further configured for selective axial displacement in a direction parallel to the main axis separate from lateral displacement in a direction transverse to the main axis.

13. The device of claim 11, wherein each of the first and second sets of petals is further configured for axial displacement in a direction parallel to the main axis.

14. The device of claim 1, wherein at least a portion of an external surface of the main body carries threads.

15. The device of claim 1, wherein each petal within the first set of petals carries threads.

16. The device of claim 1, wherein the first set of petals is configured for selective lateral displacement relative to the main axis concurrent with rotational motion of the main body.

17. The device of claim 1, further comprising:
a displacement control member disposed parallel to the main axis along a portion of the main body's length; and
a force transfer mechanism coupled to the displacement control member and the first set of petals, the force transfer mechanism configured to convert a force imparted to the displacement control member to a lateral displacement of the first set of petals.

18. The device of claim 17, wherein the force imparted to the displacement control member comprises a rotational force.

19. The device of claim 17, wherein the displacement control member comprises a rod disposed parallel to the main axis, and wherein the force transfer mechanism comprises one of a rotatable plate, an axially displaceable cone, an axially displaceable cylinder, and a gear.

20. The device of claim 17, further comprising a petal displacement control interface accessible at a proximal end of the device and configured for mating engagement with a force transfer element external to the device, the petal displacement control interface coupled to the displacement control member.

21. The device of claim 20, wherein the petal displacement control interface corresponds to a conventional standardized engagement structure configured to mate with one of a hand tool and a power tool.

22. The device of claim 21, wherein the petal displacement control interface comprises a conventional screw head interface.

23. The device of claim 17, further comprising a petal displacement guide member coupled to each petal within the set of petals and defining a petal displacement plane perpendicular to the main axis and to which a cross section of each petal within the first set of petals remains parallel during displacement of the first set of petals.

24. The device of claim 17, further comprising a lateral displacement limitation mechanism couplable to each petal within the first set of petals, the lateral displacement limitation mechanism configured for defining a lateral displacement range transverse to the main axis within which each petal within the first set of petals is displaceable.

25. A method for creating a hole using a fastener having a main body having a length and carrying a set of petals, the main body defining a first cross-sectional area, the method comprising:
inserting the fastener into an object to define a primary hole until a distal end of the fastener is disposed at a primary depth at a distal end of the primary hole; and
laterally displacing the set of petals outward from the length of the main body in the substantial absence of axial displacement of the set of petals in a direction parallel to the length of the main body to define a set of cavities extending laterally away from the length of the main body and the primary depth of the primary hole, each set of cavities defining a second cross-sectional area larger than the first cross-sectional area.

26. The method of claim 25, further comprising axially displacing the set of petals in a direction parallel to the length of the main body to enlarge the set of cavities.

27. The method of claim 26, further comprising rotating the main body within the primary hole in association with at least one of laterally displacing the set of petals and axially displacing the set of petals.
